(19) United States
(12) Patent Application Publication
(10) Pub. No.: US 2024/0152327 A1
(43) Pub. Date: May 9, 2024

(54) COMPUTING CIRCUIT, COMPUTING METHOD, AND DECODER

(71) Applicant: Taiwan Semiconductor Manufacturing Company, Ltd., Hsinchu (TW)

(72) Inventors: Win-San Khwa, Taipei City (TW); Chuan-Jia Jhang, Taichung City (TW); Yi-Lun Lu, New Taipei City (TW); Jui-Jen Wu, Hsinchu (TW); Meng-Fan Chang, Taichung City (TW)

(73) Assignee: Taiwan Semiconductor Manufacturing Company, Ltd., Hsinchu (TW)

(21) Appl. No.: 18/163,878

(22) Filed: Feb. 3, 2023

Related U.S. Application Data
(60) Provisional application No. 63/423,061, filed on Nov. 7, 2022.

(51) Int. Cl. G06F 7/544; G06F 5/01

(52) U.S. Cl. CPC G06F 7/5443; G06F 5/01

(57) ABSTRACT

A computing circuit is provided. The computing circuit is disposed in a memory device and electrically coupled to a memory cell of the memory device. The computing circuit includes a weight decoder, a multiplier, an adder tree, and an accumulator. The weight decoder is configured to obtain a compressed weight from the memory cell and generate a decoded weight based on the compressed weight. The multiplier is configured to generate a partial-product by multiplying an input signal with the decoded weight. The adder tree is configured to generate a partial-sum by performing an addition operation based on the partial-product. The accumulator is configured to generate an accumulated sum by performing an accumulation operation based on the partial-sum and output an output signal based on the accumulated sum. The accumulated sum is left shifted based on a shift signal.

### CROSS-REFERENCE TO RELATED APPLICATION

This application claims the priority benefit of U.S. provisional application Ser. No. 63/423,061, filed on Nov. 7, 2022. The entirety of the above-mentioned patent application is hereby incorporated by reference herein and made a part of this specification.

### BACKGROUND

This disclosure relates generally to in-memory computing, or compute-in-memory (CIM), and further relates to memory arrays used in data processing, such as multiply-accumulate (MAC) operations. Compute-in-memory or in-memory computing systems store information in the main random-access memory (RAM) of computers and perform calculations at memory cell level, rather than moving large quantities of data between the main RAM and data store for each computation step. Because stored data is accessed much more quickly when it is stored in RAM, compute-in-memory allows data to be analyzed in real time, enabling faster reporting and decision-making in business and machine learning applications. Efforts are ongoing to improve the performance of compute-in-memory systems.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a computing circuit in accordance with some embodiments of the present disclosure.

FIG. 2 is a schematic diagram of a compression format in accordance with some embodiments of the present disclosure.

FIG. 3A is a schematic diagram of data obtained from a compressed weight in accordance with some embodiments of the present disclosure.

FIG. 3B is a schematic diagram of implication on the multiplicand at an accumulator in accordance with some embodiments of the present disclosure.

FIG. 3C is a schematic diagram of data obtained from a compressed weight in accordance with some embodiments of the present disclosure.

FIG. 3D is a schematic diagram of implication on the multiplicand at an accumulator in accordance with some embodiments of the present disclosure.

FIG. 3E is a schematic diagram of data obtained from a compressed weight in accordance with some embodiments of the present disclosure.

FIG. 3F is a schematic diagram of implication on the multiplicand at an accumulator in accordance with some embodiments of the present disclosure.

FIG. 3G is a schematic diagram of data obtained from a compressed weight in accordance with some embodiments of the present disclosure.

FIG. 3H is a schematic diagram of implication on the multiplicand at an accumulator in accordance with some embodiments of the present disclosure.

FIG. 3I is a schematic diagram of data obtained from a compressed weight in accordance with some embodiments of the present disclosure.

FIG. 3J is a schematic diagram of data obtained from a compressed weight in accordance with some embodiments of the present disclosure.

FIG. 3K is a schematic diagram of a multiplicand table of a decoder in accordance with some embodiments of the present disclosure.

FIG. 4A is a schematic diagram of data obtained from a compressed weight in accordance with some embodiments of the present disclosure.

FIG. 4B is a schematic diagram of a distribution of the value of the weight in accordance with some embodiments of the present disclosure.

FIG. 4C is a schematic diagram of data obtained from a compressed weight in accordance with some embodiments of the present disclosure.

FIG. 4D is a schematic diagram of a distribution of the value of the weight in accordance with some embodiments of the present disclosure.

FIG. 4E is a schematic diagram of a multiplicand table of a decoder in accordance with some embodiments of the present disclosure.

FIG. 5A is a schematic diagram illustrating a computing circuit in accordance with some embodiments of the present disclosure.

FIG. 5B is a timing chart of a high speed clock in accordance with some embodiments of the present disclosure.

FIG. 6 is a schematic flowchart of a computing method of a memory device in accordance with some embodiments of the present disclosure.

### DETAILED DESCRIPTION

The following disclosure provides many different embodiments, or examples, for implementing different features of the provided subject matter. Specific examples of components, values, operations, materials, arrangements, or the like, are described below to simplify the disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In addition, terms, such as “first”, “second”, “third”, “fourth” and the like, may be used herein for ease of description to describe similar or different element(s) or feature(s) as illustrated in the figures, and may be used interchangeably depending on the order of the presence or the contexts of the description.

This disclosure relates generally to computing-in-memory (CIM). An example of applications of CIM is multiply-accumulate (MAC) operations. Computer artificial intelligence (AI) uses deep learning techniques, where a computing system may be organized as a neural network. A neural network refers to a plurality of interconnected processing nodes that enable the analysis of data, for example. Neural networks compute the product-sum between “input” and “weights” vectors. Neural networks use multiple layers of computational nodes, where deeper layers perform computations based on results of computations performed by higher layers.

Machine learning (ML) involves computer algorithms that may improve automatically through experience and by the use of data. It is seen as a part of artificial intelligence. Machine learning algorithms build a model based on sample data, known as “training data” in order to make predictions or decisions without being explicitly programmed to do so.

Neural networks may include a plurality of interconnected processing nodes that enable the analysis of data to compare an input to such “trained” data. Trained data refers to computational analysis of properties of known data to develop models to use to compare input data. An example of an application of AI and data training is found in object recognition, where a system analyzes the properties of many (e.g., thousands or more) of images to determine patterns that can be used to perform statistical analysis to identify an input object.

As noted above, neural networks compute the product-sum between “input” and “weights” vectors. Neural networks use multiple layers of computational nodes, where deeper layers perform computations based on results of computations performed by higher layers. Machine learning currently relies on the computation of dot-products and absolute difference of vectors, typically computed with MAC operations performed on the parameters, input data and weights. The computation of large and deep neural networks typically involves so many data elements. It is not practical to store them in processor cache, and thus they are usually stored in a memory.

Thus, machine learning is very computationally intensive with the computation and comparison of many different data elements. The computation of operations within a processor is orders of magnitude faster than the transfer of data between the processor and main memory resources. Placing all the data closer to the processor in caches is prohibitively expensive for the great majority of practical systems due to the memory sizes needed to store the data. Thus, the transfer of data becomes a major bottleneck for AI computations. As the data sets increase, the time and power/energy a computing system uses for moving data around can end up being multiples of the time and power used to actually perform computations.

CIM circuits thus perform operations locally within a memory without having to send data to a host processor. This may reduce the amount of data transferred between memory and the host processor, thus enabling higher throughput and performance. The reduction in data movement also reduces energy consumption of overall data movement within the computing device.

In accordance with some disclosed embodiments, a CIM device includes a memory array with memory cells arranged in rows and columns. The memory cells are configured to store weight signals, and an input driver provides input signals. A multiply and accumulation (or multiplier-accumulator) circuit performs MAC operations, where each MAC operation computes a product of two numbers and adds that product to an accumulator (or adder). In some embodiments, a processing device or a dedicated MAC unit or device may contain MAC computational hardware logic that includes a multiplier implemented in combinational logic followed by an adder and an accumulator that stores the result. The output of the accumulator may be fed back to an input of the adder, so that on each clock cycle, the output of the multiplier is added to the accumulator. Example processing devices include, but are not limited to, a microprocessor, a digital signal processor (DSP), an application-specific integrated circuit (ASIC), a field programmable gate array (FPGA), programmable logic device (PLD), and microprocessor control unit (MCU).

To improve the efficiency and reduce the consumption of the computation of a CIM device, this disclosure provides a weight compression technique and corresponding decoder with in-situ computation capability. That is, the computation is directly performed on the compressed weights, and thereby reducing the amount of bits for computation and the area required for storing the compressed weights. In addition, In-situ computation does not require the entire weight bits to be read out from the memory and decoded before the computation could start. Further, the compressed weights may have fixed data width, thus it is hardware friendly which is convenient to implement into a CIM device.

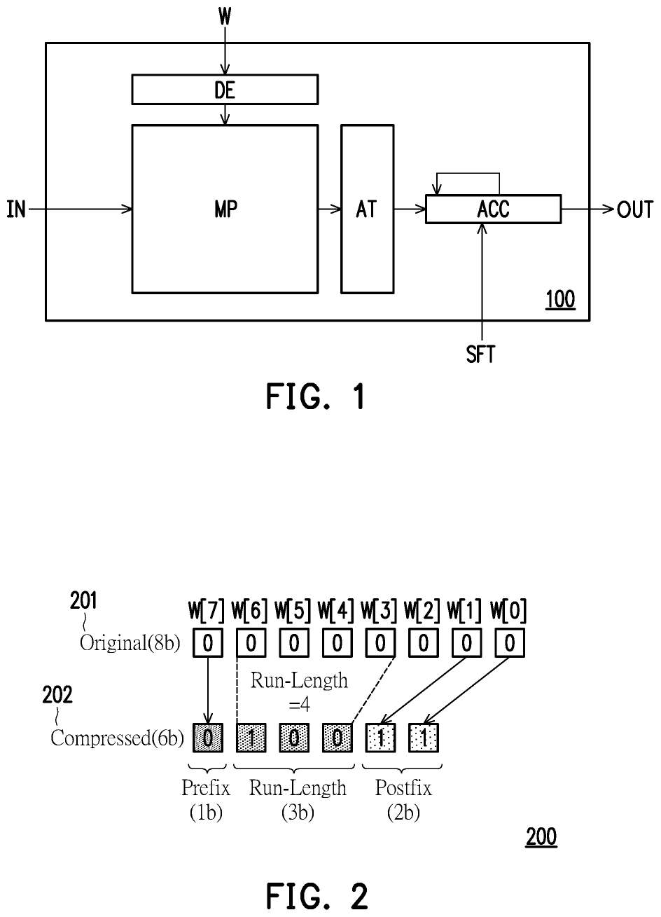

FIG. 1 is a schematic diagram illustrating a computing circuit in accordance with some embodiments of the present disclosure. With reference to FIG. 1, a computing circuit 100 can be implemented with and/or electrically coupled to a variety of memory device. The computing circuit is adapted to perform computations in the memory device so as to form a CIM device. Specifically, the computing circuit 100 includes a weight decoder DE, a multiplier MP, an adder tree AT and an accumulator ACC. The weight decoder DE is configured to obtain a compressed weight W from a memory cell of the memory device and generate a decoded weight based on the compressed weight. The multiplier MP is coupled to the weight decoder DE and is configured to generate a partial-product by multiplying an input signal IN with the decoded weight. The adder tree AT is coupled to the multiplier MP and configured to generate a partial-sum by performing an addition operation based on the partial-product. The accumulator ACC is coupled to the adder tree AT and is configured to generate an accumulated sum by performing an accumulation operation based on the partial-sum and output an output signal OUT based on the accumulated sum. Further, the accumulated sum is left shifted based on a shift signal SFT.

In one embodiment, the compressed weight W is obtained bitwise (bit by bit, e.g., from most-significant-bit (MSB) to least-significant-bit (LSB)) on each clock cycle from the memory cell of the memory device and the input signal IN is obtained wordwise (word by word) within one clock cycle. Each bit of the compressed weight W is decoded by the weight decoder DE respectively in different clock cycles. The number of the clock cycles for decoding is same as the number of the bits of the compressed weight W. The decoded weight is multiplied with the input signal IN by the multiplier to generate the partial-sum. Since the compressed weight W is obtained bitwise, there is no need to halt computation to finish reading the entire compress data and it also eliminates the time for decompression.

In one embodiment, the input signal may include a plurality of input vectors and the compressed weight may include a plurality of compressed weight vectors. At each clock cycle, the weight decoder is configured to generate a plurality of decoded weight vectors based on the compressed weight vectors. The multiplier MP is configured to perform multiplication operations on the plurality of input vectors and the plurality of decoded weight vectors to generate a plurality of partial-products of a current clock cycle. The adder tree AT is configured to add up the plurality of partial-products of the current clock cycle to generate the partial-sum of the current clock cycle. The accumulator ACC is configured to accumulate the partial-sum of the current clock cycle with the accumulated sum of a previous clock cycle to generate the accumulated sum of the current clock cycle. At the last clock cycle, the accumulator ACC is configured to output the accumulated sum of the current clock cycle as the output signal. For the convenience of explanation, the number of the input vectors and the numbers of the compressed vectors are assumed as one. However, the number of the input vectors and the numbers of the compressed vectors may vary as the design needs and this disclosure does limited thereto.

FIG. 2 is a schematic diagram of a compression format in accordance with some embodiments of the present disclosure. With reference to FIG. 2, an original weight 201 is compressed to a compressed weight 202. In this embodiment, the original weight 201 includes 8 bits and the compressed weight 202 includes 6 bit, but this disclosure is not limited thereto. The original weight 201 represents the data in the form of 2's complement. W[7] to W[0] of the original weight 201 are used to represent each bit from the most significant bit (MSB) to the least significant bit (LSB) of the original weight 201, respectively.

In this embodiment, the compressed weight 202 includes three parts: prefix (1 bit), run-length (3 bits), and postfix (2 bits). The prefix of the compressed weight 202 is directly obtained from the MSB (W[7]) of the original weight 201, which indicates the data is signed as negative or unsigned as positive. While the original weight 201 is signed (negative), the prefix is “1”, and while the original weight 201 is unsigned (positive), the prefix is “0”. It is noted that, this disclosure does not limit the number of the bits of the original weight 201 and the number of the bits of the compressed weight 202. In one embodiment, the compressed weight 202 includes 7 bits and the numbers of the bits of the prefix, the run-length, and the postfix are 1, 3, and 3, respectively. In another embodiment, the compressed weight 202 includes 5 bits and the numbers of the bits of the prefix, the run-length, and the postfix are 1, 2, and 2, respectively.

The run-length of the compressed weight 202 indicates the number of the following bits right after the MSB (W[7]) of the original weight 201 that repeats the same value of the MSB. In one embodiment, the following four bits (W[6] to W[3]) right after the MSB (W[7]) of the original weight 201 repeat the value of the MSB (W[7]) of the original weight 201. Since the number of the following bits right after the MSB repeats the same value of the MSB (W[7]) of the original weight 201 is four, the run-length of the compressed weight 202 is “100” (i.e., decimal “4”). Further, since the number of bits after the MSB repeats the same value of the MSB (W[7]) is four, it also indicates that the value of the next bit (W[2]) after the four bits (W[6] to W[3]) of the original weight 201 is different from the value of the MSB (W[7]). That is, while the value of the run-length of the compressed weight 202 is N, the data of N+1 bits of the original weight 201 may be represented by the run-length of the compressed weight 202.

Moreover, the bits of the original weight 201 have not been represented by the prefix and run-length of the compressed 202 will be directed represented by the postfix of the compressed weight 202. In one embodiment, the MSB (W[7]) of the original weight 201 is represented by the prefix of the compressed weight 202 and the second bit to the sixth bit (W[6] to W[2]) of the original weight 201 are represented by the run-length of the compressed weight 202. In other words, W[1] and W[0] of the original weight 201 would be represented by the postfix.

It is noted that, while the number of the remaining bits of the original weight 201 is more than the number of bits of the postfix of the compressed weight 202, the higher bits of the remaining bits of the original weight 201 would be represented by the postfix of the compressed weight 202 and the rest of the remaining bits of the original weight 201 would be discarded. Comparing with the value of higher bits of the remaining bits of the original weight 201, the value of the rest of the remaining bits of the original weight 201 are orders of magnitude smaller, thus the influence of discards these bits is negligible. In other words, the higher bits of the remaining bits of the original weight 201 is more meaningful than the rest of the remaining bits of the original weight 201. That is, the discarded bits represent a lesser portion of the original data. Hence, the compressed weight 202 could still accurately represent the value of original weight 201. Therefore, even the rest of the remaining bits of the original weight 201 are discarded, the compressed weight 202 could still highly accurately represents the original weight 201.

It is worth mentioned that, for convolutional neural network (CNN), the values of the weight tend to be close to a certain range from zero. That is, while the weight is represented in the form of 2's complement, the values of the bits right after the MSB tend to have a high probability to repeat the value of the MSB and the rest of the bits tend to have a low probability to repeat the value of the MSB. By using the unique characteristic of the weight, the original weight 201 is compressed to the compressed weight 202. Therefore, the amount of bits for computation and the area required for storing the compressed weights is reduced and the fixed data width of the compressed weights is hardware friendly which is convenient to implement into a CIM device.

With reference to FIG. 1 and FIG. 2, the compressed weight 202 is decoded bitwise (bit by bit) by the weight decoder DE to indicate the data of the original weight 201 during a plurality of clock cycles. The number of the plurality of clock cycles is same as the number of the bits of the compressed weight 202. From the first clock cycle to the last clock cycle, the MSB to the LSB of the compressed weight 202 is decoded, respectively. During the decoding, the weight decoder DE is configured to convert an undetermined bit of the decoded weight to a determined bit or to remain the undetermined bit undetermined based on each bit of the compressed weight 202, respectively, at each clock cycle of the plurality of clock cycles. In one embodiment, during the each clock cycle, one bit of the compressed weight 202 represents a first number of bit(s) of the original weight 201, then the first number of undetermined bit(s) of the decoded weight are converted to determined bits. In one embodiment, during the each clock cycle, one bit of the compressed weight 202 represents none of the bits of the original weight 201, then none of the undetermined bits of the decoded weight are determined. The details of how the compressed weight 202 is decoded in the each clock cycle will be explained in the following paragraphs.

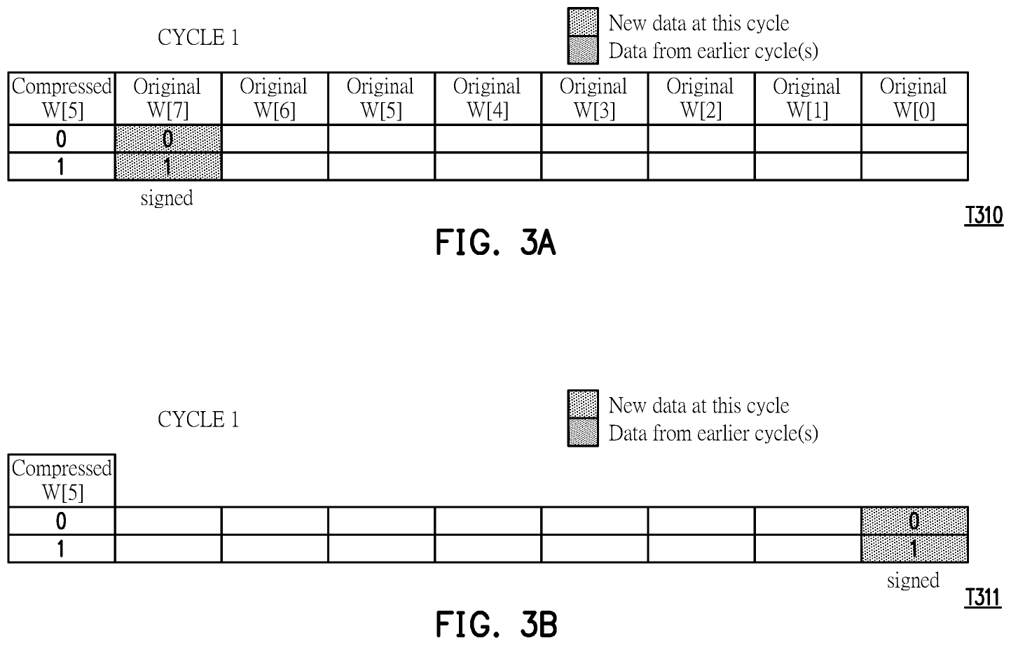

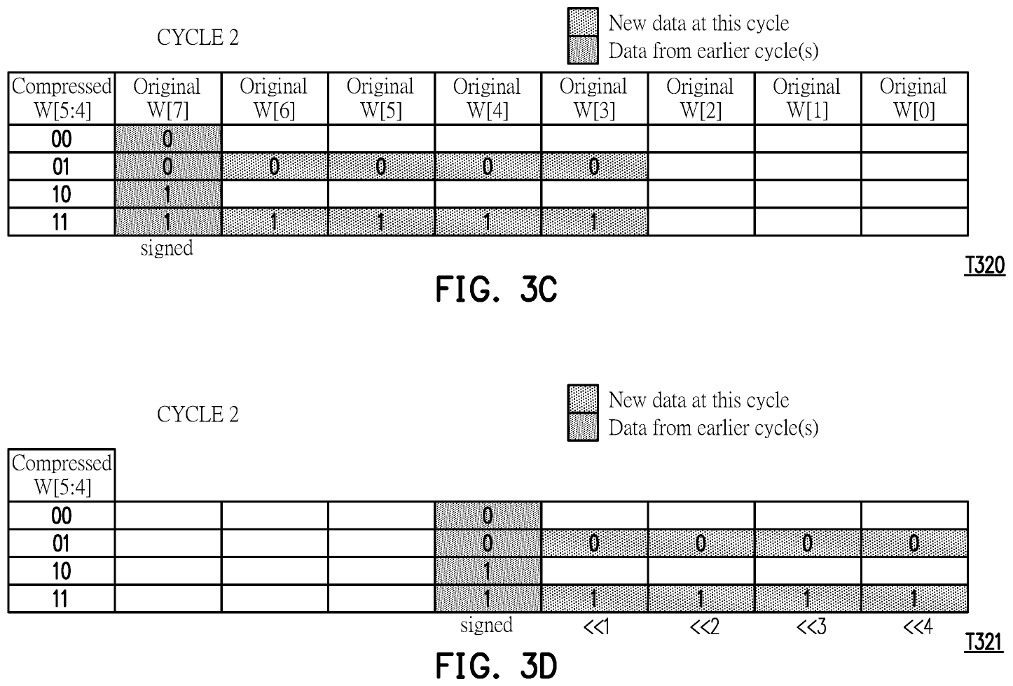

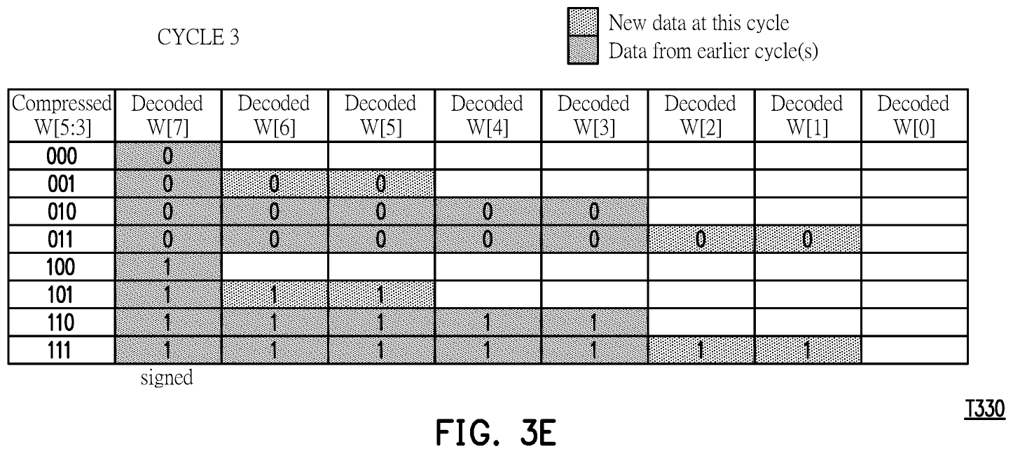

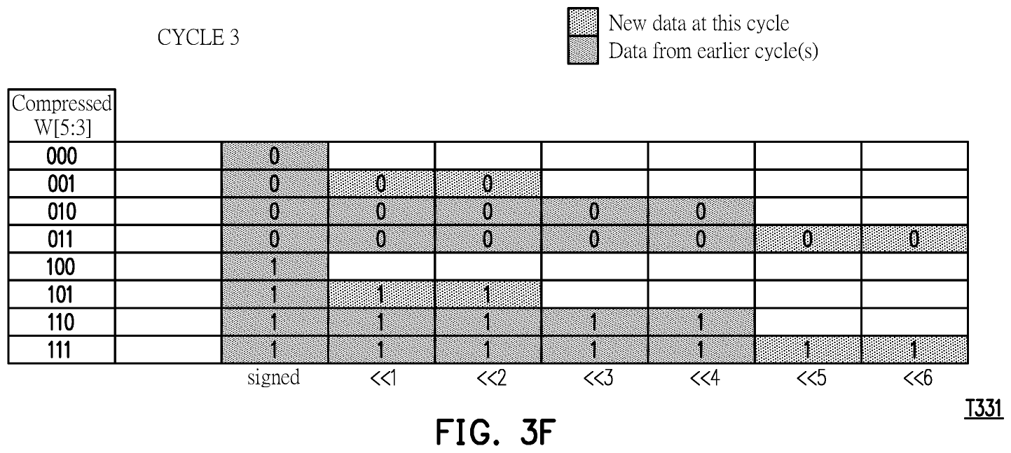

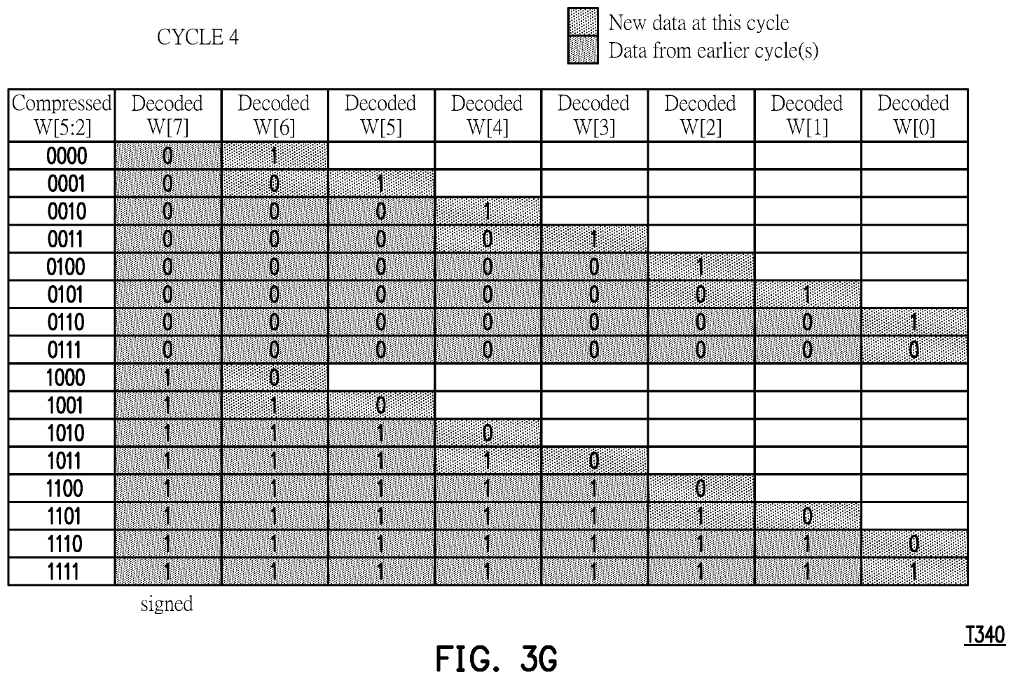

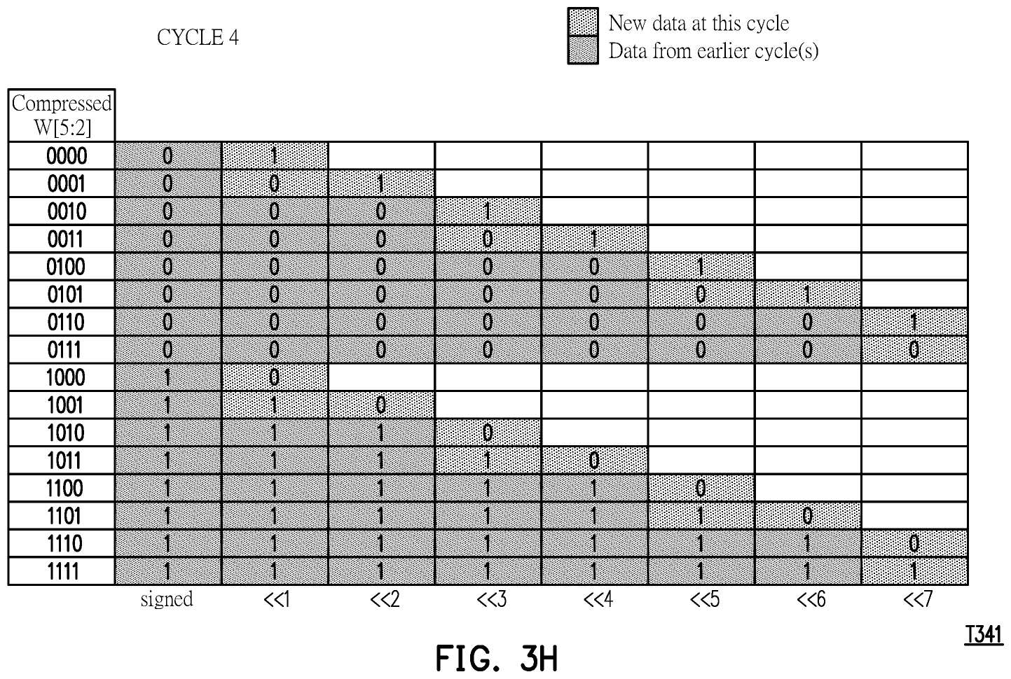

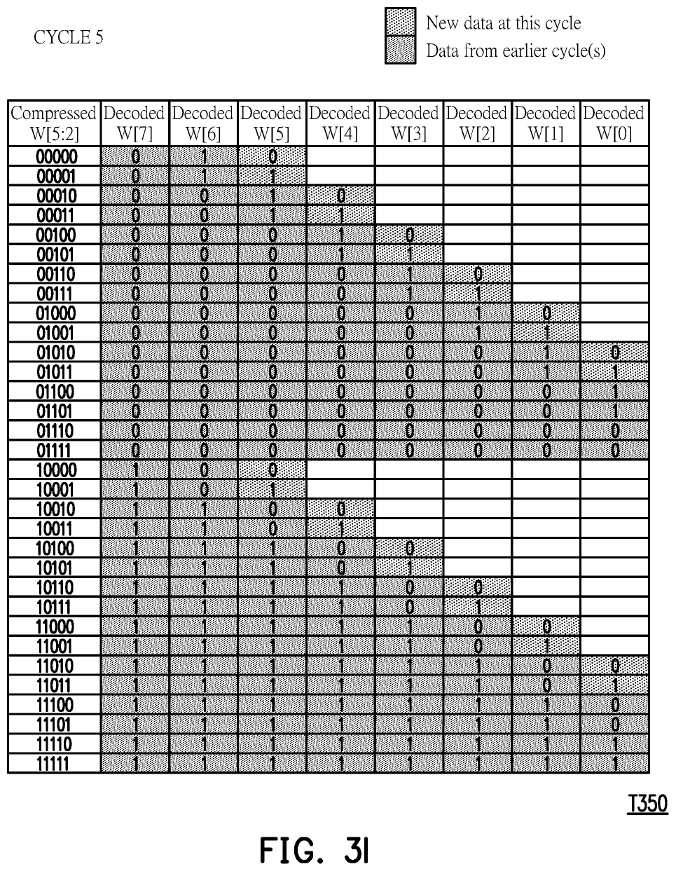

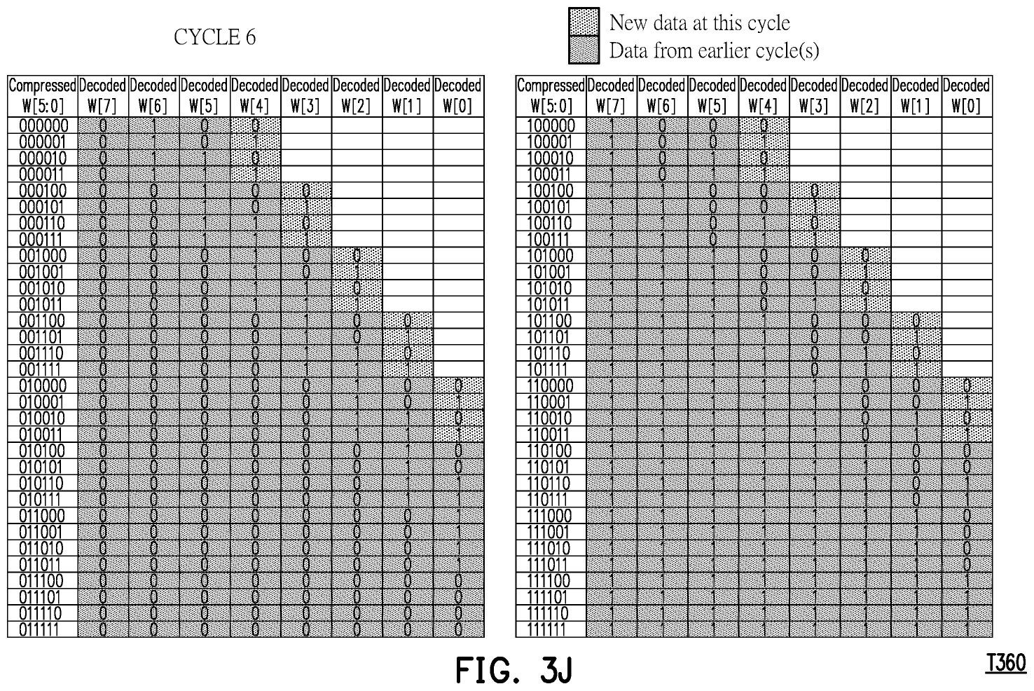

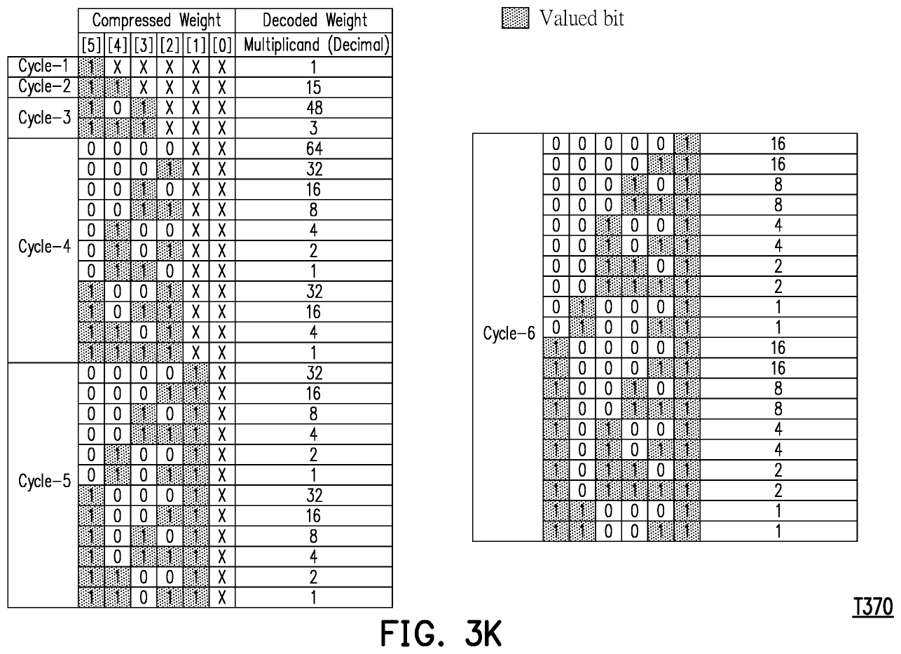

FIG. 3A is a schematic diagram of data obtained from a compressed weight in accordance with some embodiments of the present disclosure. With reference to FIG. 1 to FIG. 3A, in this embodiment, the original weight 201 includes 8 bits and the compressed weight 202 includes 6 bit. The numbers of bits of the prefix, run-length, and postfix of the compressed weight 202 are 1, 3, and 2, respectively. W[7] to W[0] of the original weight 201 are used to represent each bit from the MSB to the LSB of the original weight 201, respectively. Further, W[5] to W[0] of the compressed weight 202 are used to represent each bit from the MSB to the LSB of the original weight 202, respectively.

As shown in a table T310 of FIG. 3A, the leftmost column indicates the bit of the compressed weight 202 has been decoded and the rest of the columns indicate the data decoded from the compressed weight which reflects the original weight 201. At a cycle 1 of the compressed weight 202 being decoded to the decoded weight, the MSB (W[5]) of the compressed weight 202 is decoded to obtain the data of the MSB (W[7]) of the original weight 201. Specifically, the MSB of the decoded weight, is directly obtained from the MSB of the compressed weight 202, which is called the prefix and indicated the decoded weight is signed as negative or unsigned as positive. The MSB of the decoded weight is multiplied with input signal IN by the multiplier MP to generate a partial-product. Based on the partial-product from the multiplier, a partial-sum is generated by the adder tree AT. Based on the partial-sum from the adder tree AT, an accumulated sum is generated by the accumulator ACC.

FIG. 3B is a schematic diagram of implication on the multiplicand at an accumulator in accordance with some embodiments of the present disclosure. As shown in a table T311 of FIG. 3B, an implication on the multiplicand at the accumulator ACC at the cycle 1 is depicted. It is noted that, instead of being multiplied with the original weight 201, the input signal IN is multiplied with the determined data of the decoded weight which is decoded from the first bit (W[5]) of the compressed weight 202. Further, the determined data of the decoded weight is a multiplicand during the multiplication by the multiplier MP and the value of the multiplicand differs for different compressed weights 202.

In one embodiment, the value of W[5] of the compressed weight 202 is “0”. That is, at the cycle 1, the newly determined data reflects that the first bit (W[7]) of the original weight 201 is “0”. It is noted that, the newly determined “0” at the cycle 1 actually stands for the original weight is unsigned. Therefore, the multiplicand used to be multiplied with the input signal IN is “0”.

In one embodiment, the value of W[5] of the compressed weight 202 is “1”. That is, at the cycle 1, the newly determined data reflects that the first bit (W[7]) of the original weight 201 is “1”. It is noted that, the newly determined “1” at the cycle 1 actually stands for the original weight is signed. Therefore, the multiplicand used to be multiplied with the input signal IN is “1”.

FIG. 3C is a schematic diagram of data obtained from a compressed weight in accordance with some embodiments of the present disclosure. With reference to FIG. 1 to FIG. 3C, at a cycle 2 of the compressed weight 202 being decoded to the decoded weight, the second bit (W[4]) of the compressed weight 202 is decoded to obtain the data of the original weight 201. It is noted that, the second bit of the compressed weight 202 is the first bit of the run-length. In this embodiment, since the run-length has three bits, the first bit of the run-length indicates whether the following four bits after the MSB of the decoded weight which reflects the original weight 201 are same as the MSB or not.

As shown in a table T320 of FIG. 3C, the leftmost column indicates the bits of the compressed weight 202 have been decoded and the rest of the columns indicate the data decoded from the compressed weight which reflects the original weight 201. Specifically, the first bit to the second bit (W[5:4]) have been decoded, and the second bit (W[4]) of the compressed weight 202 is decoded at the cycle 2 to obtain the data of the decoded weight which reflects the data after the MSB of the original weight 201.

In one embodiment, the value of W[5:4] of the compressed weight 202 is “01”. That is, the value of the MSB (W[7]) of the original weight 201 is “0” and the values of the four bits (W[6] to W[3]) after the MSB of the original weight 201 are also “0”.

In one embodiment, the value of W[5:4] of the compressed weight 202 is “11”. That is, the value of the MSB (W[7]) of the original weight 201 is “1” and the values of the four bits (W[6] to W[3]) after the MSB of the original weight 201 are also “1”.

In one embodiment, the value of W[5:4] of the compressed weight 202 is “00” or “10”. That is, the first bit (W[6]) of the run-length of the compressed weight 202 is “0” and the values of the four bits (W[6] to W[3]) after the MSB of the original weight 201 does not repeat exact four times of the value of the MSB.

FIG. 3D is a schematic diagram of implication on the multiplicand at an accumulator in accordance with some embodiments of the present disclosure. As shown in a table T321 of FIG. 3D, an implication on the multiplicand at the accumulator ACC at the cycle 2 is depicted. It is noted that, instead of being multiplied with the original weight 201, the input signal IN is multiplied with the determined data of the decoded weight which is decoded from the second bit (W[4]) of the compressed weight 202. Further, the determined data of the decoded weight is a multiplicand during the multiplication by the multiplier MP and the value of the multiplicand differs for different compressed weights 202. Furthermore, since the input signal IN is multiplied with the multiplicand of the decoded weight, for the purposed of obtaining the correct value, before performing the accumulation of the accumulated sum of the previous clock cycle (cycle 1) and the partial-sum of the current clock cycle (cycle 2) by the accumulator ACC, the accumulated sum is necessary to be left-shifted.

At the cycle 2, the second bit (W[4]) of the compressed weight 202 is decoded and the second bit (W[4]) of the compressed weight 202 is the first bit of the run-length which indicates whether the following four bits after the determined data of decoded weight at the cycle 1 are same as the MSB of the original weight 201 or not. Therefore, the accumulated sum of the cycle 1 should be left-shifted 4 bit and then accumulated with the partial-sum of the cycle 2 from the adder tree AT. That is, the accumulated sum of the accumulator ACC has been left-shifted 4 bits from the cycle 1 to the cycle 2.

In one embodiment, the value of W[5:4] of the compressed weight 202 is “01”. That is, at the cycle 2, the newly determined data reflects that the second bit (W[6]) to the fifth bit (W[3]) of the original weight 201 are “0”, “0”, “0”, and “0”. It is noted that, the newly determined “0”, “0”, “0”, and “0” at the cycle 2 actually stand for “0000” in binary which means “0” in decimal. Therefore, the multiplicand used to be multiplied with the input signal IN is “0”.

In one embodiment, the value of W[5:4] of the compressed weight 202 is “11”. That is, at the cycle 2, the newly determined data reflects that the second bit (W[6]) to the fifth bit (W[3]) of the original weight 201 are “1”, “1”, “1”, and “1”. It is noted that, the newly determined “1”, “1”, “1”, and “1” at the cycle 2 actually stand for “1111” in binary which means “15” in decimal. Therefore, the multiplicand used to be multiplied with the input signal IN is “15”.

In one embodiment, the value of W[5:4] of the compressed weight 202 is “00” or “10”. That is, at the cycle 2, the values of the four bits (W[6] to W[3]) after the decoded data (W[7], i.e., MSB) of the original weight 201 does not repeat exact four times of the value of the MSB. In other words, at the cycle 2, the four bits (W[6] to W[3]) after the decoded data (W[7], i.e., MSB) of the decoded weight are undetermined data. It is noted that, no newly determined data reflects that the second bit (W[6]) to the fifth bit (W[3]) of the original weight 201 is obtained. Therefore, the multiplicand used to be multiplied with the input signal IN is “0”.

FIG. 3E is a schematic diagram of data obtained from a compressed weight in accordance with some embodiments of the present disclosure. With reference to FIG. 1 to FIG. 3E, at a cycle 3 of the compressed weight 202 being decoded to the decoded weight, the third bit (W[3]) of the compressed weight 202 is decoded to obtain the data of the original weight 201. It is noted that, the third bit of the compressed weight 202 is the second bit of the run-length. In this embodiment, since the run-length has three bits, the second bit of the run-length indicates whether the following two bits of the decoded weight which reflects the original weight 201 are same as the MSB or not.

As shown in a table T330 of FIG. 3E, the leftmost column indicates the bits of the compressed weight 202 have been decoded and the rest of the columns indicate the data decoded from the compressed weight which reflects the original weight 201. Specifically, the first bit to the third bit (W[5:3]) have been decoded, and the third bit (W[3]) of the compressed weight 202 is decoded at the cycle 3 to obtain the data of the decoded weight which reflects the data after the MSB of the original weight 201.

In one embodiment, the value of W[5:3] of the compressed weight 202 is “001”. That is, the value of the MSB (W[7]) of the original weight 201 is “0” and the values of the two bits (W[6] to W[5]) after the MSB of the original weight 201 are also “0”.

In one embodiment, the value of W[5:3] of the compressed weight 202 is “101”. That is, the value of the MSB (W[7]) of the original weight 201 is “1” and the values of the two bits (W[6] to W[5]) after the MSB of the original weight 201 are also “1”.

In one embodiment, the value of W[5:3] of the compressed weight 202 is “011”. That is, the value of the MSB (W[7]) of the original weight 201 is “0” and the values of the two bits (W[2] to W[1]) after the four bits (W[6] to W[3]) after the MSB of the original weight 201 are also “0”. In other words, the values of the six bits (W[6] to W[1]) after the MSB are same as the value of the MSB.

In one embodiment, the value of W[5:3] of the compressed weight 202 is “111”. That is, the value of the MSB (W[7]) of the original weight 201 is “1” and the values of the two bits (W[2] to W[1]) after the four bits (W[6] to W[3]) after the MSB of the original weight 201 are also “1”. In other words, the values of the six bits (W[6] to W[1]) after the MSB are same as the value of the MSB.

In one embodiment, the value of W[5:3] of the compressed weight 202 is “000” or “100”. That is, the second bit (W[5]) of the run-length of the compressed weight 202 is “0” and the values of the two bits (W[6] to W[5]) after the MSB of the original weight 201 does not repeat exact two times of the value of the MSB.

In one embodiment, the value of W[5:3] of the compressed weight 202 is “010” or “110”. That is, the second bit (W[5]) of the run-length of the compressed weight 202 is “0” and the values of the two bits (W[2] to W[1]) after the four bits (W[6] to W[3]) after the MSB of the original weight 201 does not repeat exact two times of the value of the MSB.

FIG. 3F is a schematic diagram of implication on the multiplicand at an accumulator in accordance with some embodiments of the present disclosure. As shown in a table T331 of FIG. 3F, an implication on the multiplicand at the accumulator ACC at the cycle 3 is depicted. It is noted that, instead of being multiplied with the original weight 201, the input signal IN is multiplied with the determined data of the decoded weight which is decoded from the third bit (W[3]) of the compressed weight 202. Further, the determined data of the decoded weight is a multiplicand during the multiplication by the multiplier MP and the value of the multiplicand differs for different compressed weights 202. Furthermore, since the input signal IN is multiplied with the multiplicand of the decoded weight, for the purposed of obtaining the correct value, before performing the accumulation of the accumulated sum of the previous clock cycle (cycle 2) and the partial-sum of the current clock cycle (cycle 3) by the accumulator ACC, the accumulated sum is necessary to be left-shifted.

At the cycle 3, the third bit (W[3]) of the compressed weight 202 is decoded and the third bit (W[3]) of the compressed weight 202 is the second bit of the run-length which indicates whether the following two bits after the determined data of decoded weight at the cycle 2 are same as the MSB of the original weight 201 or not. Therefore, the accumulated sum of the cycle 2 should be left-shifted 2 bits and then accumulated with the partial-sum of the cycle 3 from the adder tree AT. That is, the accumulated sum of the accumulator ACC has been left-shifted 6 bits from the cycle 1 to the cycle 3.

In one embodiment, the value of W[5:3] of the compressed weight 202 is “001”. That is, at the cycle 3, the newly determined data reflects that the second bit (W[6]) to the third bit (W[5]) of the original weight 201 are “0” and “0”. It is noted that, the newly determined “0”, and “0” at the cycle 3 actually stand for “000000” in binary which means “0” in decimal. Therefore, the multiplicand used to be multiplied with the input signal IN is “0”.

In one embodiment, the value of W[5:3] of the compressed weight 202 is “101”. That is, at the cycle 3, the newly determined data reflects that the second bit (W[6]) to the third bit (W[5]) of the original weight 201 are “1” and “1”. It is noted that, the newly determined “1”, and “1” at the cycle 3 actually stand for “110000” in binary which means “48” in decimal. Therefore, the multiplicand used to be multiplied with the input signal IN is “48”.

In one embodiment, the value of W[5:3] of the compressed weight 202 is “011”. That is, at the cycle 3, the newly determined data reflects that the sixth bit (W[2]) to the seventh bit (W[1]) of the original weight 201 are “0” and “0”. It is noted that, the newly determined “0”, and “0” at the cycle 3 actually stand for “00” in binary which means “0” in decimal. Therefore, the multiplicand used to be multiplied with the input signal IN is “0”.

In one embodiment, the value of W[5:3] of the compressed weight 202 is “111”. That is, at the cycle 3, the newly determined data reflects that the sixth bit (W[2]) to the seventh bit (W[1]) of the original weight 201 are “1” and “1”. It is noted that, the newly determined “1”, and “1” at the cycle 3 actually stand for “11” in binary which means “3” in decimal. Therefore, the multiplicand used to be multiplied with the input signal IN is “3”.

In one embodiment, the value of W[5:4] of the compressed weight 202 is “000” or “100”. That is, at the cycle 3, the values of the following two bit (W[6] to W[5]) after the determined data (W[7], i.e., MSB) of the decoded weight at the cycle 2 does not repeat exact two times of the value of the MSB. In other words, at the cycle 3, the two bits (W[6] to W[5]) after the determined data (W[7], i.e., MSB) of the decoded weight at the cycle 2 are undetermined data. It is noted that, no newly determined data reflects that the second bit (W[6]) to the third bit (W[5]) of the original weight 201 is obtained. Therefore, the multiplicand used to be multiplied with the input signal IN is “0”.

In one embodiment, the value of W[5:4] of the compressed weight 202 is “010” or “110”. That is, at the cycle 3, the values of the following two bit (W[2] to W[1]) after the determined data of the decoded weight at the cycle 2 does not repeat exact two times of the value of the MSB. In other words, at the cycle 3, the two bits (W[2] to W[1]) after the determined data (W[7] to W[3]) of the decoded weight at the cycle 2 are undetermined data. It is noted that, no newly determined data reflects that the sixth bit (W[2]) to the seventh bit (W[1]) of the original weight 201 is obtained. Therefore, the multiplicand used to be multiplied with the input signal IN is “0”.

FIG. 3G is a schematic diagram of data obtained from a compressed weight in accordance with some embodiments of the present disclosure. With reference to FIG. 1 to FIG. 3G, at a cycle 4 of the compressed weight 202 being decoded to the decoded weight, the fourth bit (W[2]) of the compressed weight 202 is decoded to obtain the data of the original weight 201. It is noted that, the fourth bit of the compressed weight 202 is the third bit of the run-length. In this embodiment, since the run-length has three bits, the third bit of the run-length indicates whether the following one bit of the decoded weight which reflects the original weight 201 are same as the MSB or not. Further, since the three bits of the run-length have been all decoded, the next bit of the decoded weight which reflects the original weight 201 and has different value from the MSB may be also obtained.

As shown in a table T340 of FIG. 3G, the leftmost column indicates the bits of the compressed weight 202 have been decoded and the rest of the columns indicate the data decoded from the compressed weight which reflects the original weight 201. Specifically, the first bit to the fourth bit (W[5:2]) have been decoded, and the fourth bit (W[2]) of the compressed weight 202 is decoded at the cycle 4 to obtain the data after the determined bit(s) of the decoded weight at the cycle 4 which reflects the data of the original weight 201.

In one embodiment, the value of W[5:2] of the compressed weight 202 is “0001”. That is, the value of the MSB (W[7]) of the original weight 201 is “0” and the value of the one bit (W[6]) after the MSB of the original weight 201 is also “0”. Further, the value of the next bit (W[5]) of the original weight 201 is “1”, which is different from the value of the MSB.

In one embodiment, the value of W[5:2] of the compressed weight 202 is “1001”. That is, the value of the MSB (W[7]) of the original weight 201 is “1” and the value of the one bit (W[6]) after the MSB of the original weight 201 is also “1”. Further, the value of the next bit (W[5]) of the original weight 201 is “0”, which is different from the value of the MSB.

In one embodiment, the value of W[5:2] of the compressed weight 202 is “0011”. That is, the value of the MSB (W[7]) of the original weight 201 is “0” and the value of the one bit (W[4]) after the two bits (W[6] to W[5]) after the MSB of the original weight 201 is also “0”. In other words, the values of the three bits (W[6] to W[4]) after the MSB are same as the value of the MSB. Further, the value of the next bit (W[3]) of the original weight 201 is “1”, which is different from the value of the MSB.

In one embodiment, the value of W[5:2] of the compressed weight 202 is “1011”. That is, the value of the MSB (W[7]) of the original weight 201 is “1” and the value of the one bit (W[4]) after the two bits (W[6] to W[5]) after the MSB of the original weight 201 is also “1”. In other words, the values of the three bits (W[6] to W[4]) after the MSB are same as the value of the MSB. Further, the value of the next bit (W[3]) of the original weight 201 is “0”, which is different from the value of the MSB.

In one embodiment, the value of W[5:2] of the compressed weight 202 is “0101”. That is, the value of the MSB (W[7]) of the original weight 201 is “0” and the value of the one bit (W[2]) after the four bits (W[6] to W[3]) after the MSB of the original weight 201 is also “0”. In other words, the values of the five bits (W[6] to W[2]) after the MSB are same as the value of the MSB. Further, the value of the next bit (W[1]) of the original weight 201 is “1”, which is different from the value of the MSB.

In one embodiment, the value of W[5:2] of the compressed weight 202 is “1101”. That is, the value of the MSB (W[7]) of the original weight 201 is “1” and the value of the one bit (W[2]) after the four bits (W[6] to W[3]) after the MSB of the original weight 201 is also “1”. In other words, the values of the five bits (W[6] to W[2]) after the MSB are same as the value of the MSB. Further, the value of the next bit (W[1]) of the original weight 201 is “1”, which is different from the value of the MSB.

In one embodiment, the value of W[5:2] of the compressed weight 202 is “0111”. That is, the value of the MSB (W[7]) of the original weight 201 is “0” and the value of the one bit (W[2]) after the six bits (W[6] to W[1]) after the MSB of the original weight 201 is also “0”. In other words, the values of the seven bits (W[6] to W[0]) after the MSB are same as the value of the MSB.

In one embodiment, the value of W[5:2] of the compressed weight 202 is “1111”. That is, the value of the MSB (W[7]) of the original weight 201 is “1” and the value of the one bit (W[2]) after the six bits (W[6] to W[1]) after the MSB of the original weight 201 is also “1”. In other words, the values of the seven bits (W[6] to W[0]) after the MSB are same as the value of the MSB.

In one embodiment, the value of W[5:2] of the compressed weight 202 is “0000” or “1000”. That is, the third bit (W[4]) of the run-length of the compressed weight 202 is “0” and the values of the one bit (W[6]) after the MSB of the original weight 201 does not repeat exact one time of the value of the MSB. Further, the value of the one bit (W[6]) after the MSB of the original weight 201 is different from the value of the MSB (W[7]).

In one embodiment, the value of W[5:2] of the compressed weight 202 is “0010” or “1010”. That is, the third bit (W[4]) of the run-length of the compressed weight 202 is “0” and the values of the one bit (W[4]) after the two bits (W[6] to W[5]) after the MSB of the original weight 201 does not repeat exact one time of the value of the MSB. Further, the value of the one bit (W[4]) after the two bits (W[6] to W[5]) after the MSB of the original weight 201 is different from the value of the MSB (W[7]).

In one embodiment, the value of W[5:2] of the compressed weight 202 is “0100” or “1100”. That is, the third bit (W[4]) of the run-length of the compressed weight 202 is “0” and the values of the one bit (W[2]) after the four bits (W[6] to W[3]) after the MSB of the original weight 201 does not repeat exact one time of the value of the MSB. Further, the value of the one bit (W[2]) after the four bits (W[6] to W[3]) after the MSB of the original weight 201 is different from the value of the MSB (W[7]).

In one embodiment, the value of W[5:2] of the compressed weight 202 is “0110” or “1110”. That is, the third bit (W[4]) of the run-length of the compressed weight 202 is “0” and the values of the one bit (W[0]) after the six bits (W[6] to W[1]) after the MSB of the original weight 201 does not repeat exact one time of the value of the MSB. Further, the value of the one bit (W[0]) after the six bits (W[6] to W[1]) after the MSB of the original weight 201 is different from the value of the MSB (W[7]).

It is noted that, at the cycle 4, for the value of W[5:2] of the compressed weight 202 is “0110”, “0111”, “1110” or “1111”, the eight bits (W[7] to W[0]) of the original weight 201 are all determined. That is, although the compressed weight 202 includes six bits, the data of the original weight 201 compressed in the compressed weight 202 may be fully obtained without decoding the all six bits of the compressed weight 202. In other words, the efficiency of the computation is improved and the energy consumption is reduced. In one embodiment, for the compressed weight 202 which all the bits are determined, at the next clock cycle, the next bit of the compressed weight 202 may be processed as dummy bit and the computation at the next clock cycle will be neglected. In another embodiment, for the compressed weight 202 which all the bits are determined, at the next clock cycle, the decoding of the next clock cycle may be skipped to further improve the computation efficiency and reduce the energy consumption.

FIG. 3H is a schematic diagram of implication on the multiplicand at an accumulator in accordance with some embodiments of the present disclosure. As shown in a table T341 of FIG. 3H, an implication on the multiplicand at the accumulator ACC at the cycle 4 is depicted. It is noted that, instead of being multiplied with the original weight 201, the input signal IN is multiplied with the determined data of the decoded weight which is decoded from the fourth bit (W[2]) of the compressed weight 202. Further, the determined data of the decoded weight is a multiplicand during the multiplication by the multiplier MP and the value of the multiplicand differs for different compressed weights 202. Furthermore, since the input signal IN is multiplied with the multiplicand of the decoded weight, for the purposed of obtaining the correct value, before performing the accumulation of the accumulated sum of the previous clock cycle (cycle 3) and the partial-sum of the current clock cycle (cycle 4) by the accumulator ACC, the accumulated sum is necessary to be left-shifted.

At the cycle 4, the fourth bit (W[2]) of the compressed weight 202 is decoded and the fourth bit (W[2]) of the compressed weight 202 is the third bit of the run-length which indicates whether the following one bit after the determined data of decoded weight at the cycle 3 are same as the MSB of the original weight 201 or not. Therefore, the accumulated sum of the cycle 3 should be left-shifted 1 bit and then accumulated with the partial-sum of the cycle 4 from the adder tree AT. That is, the accumulated sum of the accumulator ACC has been left-shifted 7 bits from the cycle 1 to the cycle 4.

In one embodiment, the value of W[5:2] of the compressed weight 202 is “0000”. That is, at the cycle 4, the newly determined data reflects that the second bit (W[6]) of the original weight 201 is “1”. It is noted that, the newly determined “1” at the cycle 4 actually stands for “1000000” in binary which means “64” in decimal. Therefore, the multiplicand used to be multiplied with the input signal IN is “64”.

In one embodiment, the value of W[5:2] of the compressed weight 202 is “0001”. That is, at the cycle 4, the newly determined data reflects that the second bit (W[6]) and the third bit (W[5]) of the original weight 201 are “0” and “1”. It is noted that, the newly determined “0” and “1” at the cycle 4 actually stand for “0100000” in binary which means “32” in decimal. Therefore, the multiplicand used to be multiplied with the input signal IN is “32”.

In one embodiment, the value of W[5:2] of the compressed weight 202 is “0010”. That is, at the cycle 4, the newly determined data reflects that the fourth bit (W[4]) of the original weight 201 is “1”. It is noted that, the newly determined “1” at the cycle 4 actually stands for “10000” in binary which means “16” in decimal. Therefore, the multiplicand used to be multiplied with the input signal IN is “16”.

In one embodiment, the value of W[5:2] of the compressed weight 202 is “0011”. That is, at the cycle 4, the newly determined data reflects that the fourth bit (W[4]) and the fifth bit (W[3]) of the original weight 201 are “0” and “1”. It is noted that, the newly determined “0” and “1” at the cycle 4 actually stand for “01000” in binary which means “8” in decimal. Therefore, the multiplicand used to be multiplied with the input signal IN is “8”.

In one embodiment, the value of W[5:2] of the compressed weight 202 is “0100”. That is, at the cycle 4, the newly determined data reflects that the sixth bit (W[2]) of the original weight 201 is “1”. It is noted that, the newly determined “1” at the cycle 4 actually stands for “100” in binary which means “4” in decimal. Therefore, the multiplicand used to be multiplied with the input signal IN is “4”.

In one embodiment, the value of W[5:2] of the compressed weight 202 is “0101”. That is, at the cycle 4, the newly determined data reflects that the sixth bit (W[2]) and the seventh bit (W[1]) of the original weight 201 are “0” and “1”. It is noted that, the newly determined “0” and “1” at the cycle 4 actually stand for “010” in binary which means “2” in decimal. Therefore, the multiplicand used to be multiplied with the input signal IN is “2”.

In one embodiment, the value of W[5:2] of the compressed weight 202 is “0110”. That is, at the cycle 4, the newly determined data reflects that the eighth bit (W[0]) of the original weight 201 is “1”. It is noted that, the newly determined “1” at the cycle 4 actually stands for “1” in binary which means “1” in decimal. Therefore, the multiplicand used to be multiplied with the input signal IN is “1”.

In one embodiment, the value of W[5:2] of the compressed weight 202 is “0111”. That is, at the cycle 4, the newly determined data reflects that the eighth bit (W[0]) of the original weight 201 is “0”. It is noted that, the newly determined “0” at the cycle 4 actually stands for “0” in binary which means “0” in decimal. Therefore, the multiplicand used to be multiplied with the input signal IN is “0”.

In one embodiment, the value of W[5:2] of the compressed weight 202 is “1000”. That is, at the cycle 4, the newly determined data reflects that the second bit (W[6]) of the original weight 201 is “0”. It is noted that, the newly determined “0” at the cycle 4 actually stands for “0000000” in binary which means “0” in decimal. Therefore, the multiplicand used to be multiplied with the input signal IN is “0”.

In one embodiment, the value of W[5:2] of the compressed weight 202 is “1001”. That is, at the cycle 4, the newly determined data reflects that the second bit (W[6]) and the third bit (W[5]) of the original weight 201 are “1” and “0”. It is noted that, the newly determined “1” and “0” at the cycle 4 actually stand for “1000000” in binary which means “64” in decimal. Therefore, the multiplicand used to be multiplied with the input signal IN is “64”.

In one embodiment, the value of W[5:2] of the compressed weight 202 is “1010”. That is, at the cycle 4, the newly determined data reflects that the fourth bit (W[4]) of the original weight 201 is “0”. It is noted that, the newly determined “0” at the cycle 4 actually stands for “00000” in binary which means “0” in decimal. Therefore, the multiplicand used to be multiplied with the input signal IN is “0”.

In one embodiment, the value of W[5:2] of the compressed weight 202 is “1011”. That is, at the cycle 4, the newly determined data reflects that the fourth bit (W[4]) and the fifth bit (W[3]) of the original weight 201 are “1” and “0”. It is noted that, the newly determined “1” and “0” at the cycle 4 actually stand for “10000” in binary which means “16” in decimal. Therefore, the multiplicand used to be multiplied with the input signal IN is “16”.

In one embodiment, the value of W[5:2] of the compressed weight 202 is “1100”. That is, at the cycle 4, the newly determined data reflects that the sixth bit (W[2]) of the original weight 201 is “0”. It is noted that, the newly determined “0” at the cycle 4 actually stands for “000” in binary which means “0” in decimal. Therefore, the multiplicand used to be multiplied with the input signal IN is “0”.

In one embodiment, the value of W[5:2] of the compressed weight 202 is “1101”. That is, at the cycle 4, the newly determined data reflects that the sixth bit (W[2]) and the seventh bit (W[1]) of the original weight 201 are “1” and “0”. It is noted that, the newly determined “1” and “0” at the cycle 4 actually stand for “100” in binary which means “4” in decimal. Therefore, the multiplicand used to be multiplied with the input signal IN is “4”.

In one embodiment, the value of W[5:2] of the compressed weight 202 is “1110”. That is, at the cycle 4, the newly determined data reflects that the eighth bit (W[0]) of the original weight 201 is “0”. It is noted that, the newly determined “0” at the cycle 4 actually stands for “0” in binary which means “0” in decimal. Therefore, the multiplicand used to be multiplied with the input signal IN is “0”.

In one embodiment, the value of W[5:2] of the compressed weight 202 is “1111”. That is, at the cycle 4, the newly determined data reflects that the eighth bit (W[0]) of the original weight 201 is “1”. It is noted that, the newly determined “1” at the cycle 4 actually stands for “1” in binary which means “1” in decimal. Therefore, the multiplicand used to be multiplied with the input signal IN is “1”.

FIG. 3I is a schematic diagram of data obtained from a compressed weight in accordance with some embodiments of the present disclosure. With reference to FIG. 1 to FIG. 3I, at a cycle of the compressed weight 202 being decoded to the decoded weight, the fifth bit (W[1]) of the compressed weight 202 is decoded to obtain the data of the original weight 201. It is noted that, the fifth bit of the compressed weight 202 is the first bit of the postfix. That is, the fifth bit of the compressed weight 202 is directly determined as the following bit of the decoded weight.

As shown in a table T350 of FIG. 3I, the leftmost column indicates the bits of the compressed weight 202 have been decoded and the rest of the columns indicate the data decoded from the compressed weight which reflects the original weight 201. Specifically, the first bit to the fifth bit (W[5:1]) have been decoded, and the fifth bit (W[1]) of the compressed weight 202 is decoded at the cycle 5 to obtain the data after the determined bit(s) of the decoded weight at the cycle 4 which reflects the data of the original weight 201. It is noted that, instead of being multiplied with the original weight 201, the input signal IN is multiplied with the determined data of the decoded weight which is decoded from the fifth bit (W[1]) of the compressed weight 202. Further, the determined data of the decoded weight is a multiplicand during the multiplication by the multiplier MP and the value of the multiplicand differs for different compressed weights 202.

In one embodiment, the value of W[5:1] of the compressed weight 202 is “00000” or “10000”. That is, at the cycle 5, the newly determined data reflects that the third bit (W[5]) of the original weight 201 is “0”. It is noted that, the newly determined “0” at the cycle 5 actually stands for “000000” in binary which means “0” in decimal. Therefore, the multiplicand used to be multiplied with the input signal IN is “0”.

In one embodiment, the value of W[5:1] of the compressed weight 202 is “00001” or “10001”. That is, at the cycle 5, the newly determined data reflects that the third bit (W[5]) of the original weight 201 is “1”. It is noted that, the newly determined “1” at the cycle 5 actually stands for “100000” in binary which means “32” in decimal. Therefore, the multiplicand used to be multiplied with the input signal IN is “32”.

In one embodiment, the value of W[5:1] of the compressed weight 202 is “00010” or “10010”. That is, at the cycle 5, the newly determined data reflects that the fourth bit (W[4]) of the original weight 201 is “0”. It is noted that, the newly determined “0” at the cycle 5 actually stands for “00000” in binary which means “0” in decimal. Therefore, the multiplicand used to be multiplied with the input signal IN is “0”.

In one embodiment, the value of W[5:1] of the compressed weight 202 is “00011” or “10011”. That is, at the cycle 5, the newly determined data reflects that the fourth bit (W[4]) of the original weight 201 is “1”. It is noted that, the newly determined “1” at the cycle 5 actually stands for “10000” in binary which means “16” in decimal. Therefore, the multiplicand used to be multiplied with the input signal IN is “16”.

In one embodiment, the value of W[5:1] of the compressed weight 202 is “00100” or “10100”. That is, at the cycle 5, the newly determined data reflects that the fifth bit (W[3]) of the original weight 201 is “0”. It is noted that, the newly determined “0” at the cycle 5 actually stands for “0000” in binary which means “0” in decimal. Therefore, the multiplicand used to be multiplied with the input signal IN is “0”.

In one embodiment, the value of W[5:1] of the compressed weight 202 is “00101” or “10101”. That is, at the cycle 5, the newly determined data reflects that the fifth bit (W[3]) of the original weight 201 is “1”. It is noted that, the newly determined “1” at the cycle 5 actually stands for “1000” in binary which means “8” in decimal. Therefore, the multiplicand used to be multiplied with the input signal IN is “8”.

In one embodiment, the value of W[5:1] of the compressed weight 202 is “00110” or “10110”. That is, at the cycle 5, the newly determined data reflects that the sixth bit (W[2]) of the original weight 201 is “0”. It is noted that, the newly determined “0” at the cycle 5 actually stands for “000” in binary which means “0” in decimal. Therefore, the multiplicand used to be multiplied with the input signal IN is “0”.

In one embodiment, the value of W[5:1] of the compressed weight 202 is “00111” or “10111”. That is, at the cycle 5, the newly determined data reflects that the sixth bit (W[2]) of the original weight 201 is “1”. It is noted that, the newly determined “1” at the cycle 5 actually stands for “100” in binary which means “4” in decimal. Therefore, the multiplicand used to be multiplied with the input signal IN is “4”.

In one embodiment, the value of W[5:1] of the compressed weight 202 is “01000” or “11000”. That is, at the cycle 5, the newly determined data reflects that the seventh bit (W[1]) of the original weight 201 is “0”. It is noted that, the newly determined “0” at the cycle 5 actually stands for “00” in binary which means “0” in decimal. Therefore, the multiplicand used to be multiplied with the input signal IN is “0”.

In one embodiment, the value of W[5:1] of the compressed weight 202 is “01001” or “11001”. That is, at the cycle 5, the newly determined data reflects that the seventh bit (W[1]) of the original weight 201 is “1”. It is noted that, the newly determined “1” at the cycle 5 actually stands for “10” in binary which means “2” in decimal. Therefore, the multiplicand used to be multiplied with the input signal IN is “2”.

In one embodiment, the value of W[5:1] of the compressed weight 202 is “01010” or “11010”. That is, at the cycle 5, the newly determined data reflects that the eighth bit (W[1]) of the original weight 201 is “0”. It is noted that, the newly determined “0” at the cycle 5 actually stands for “0” in binary which means “0” in decimal. Therefore, the multiplicand used to be multiplied with the input signal IN is “0”.

In one embodiment, the value of W[5:1] of the compressed weight 202 is “01011” or “11011”. That is, at the cycle 5, the newly determined data reflects that the eighth bit (W[1]) of the original weight 201 is “1”. It is noted that, the newly determined “1” at the cycle 5 actually stands for “1” in binary which means “1” in decimal. Therefore, the multiplicand used to be multiplied with the input signal IN is “1”.

In one embodiment, the value of W[5:1] of the compressed weight 202 is “01100”, “01101”, “01110”, “01111”, “11100”, “11101”, “11110”, or “11111”. It is noted that, since the eight bits (W[7] to W[0]) of the original weight 201 corresponding to these compressed weights 202 are all determined at the earlier clock cycle. Therefore, no newly determined data is obtained from theses weights 202 at the current clock cycle (cycle 5).

FIG. 3J is a schematic diagram of data obtained from a compressed weight in accordance with some embodiments of the present disclosure. With reference to FIG. 1 to FIG. 3J, at a cycle 6 of the compressed weight 202 being decoded to the decoded weight, the sixth bit (W[0]) of the compressed weight 202 is decoded to obtain the data of the original weight 201. It is noted that, the fifth bit of the compressed weight 202 is the second bit of the postfix. That is, the sixth bit of the compressed weight 202 is directly determined as the following bit of the decoded weight.

As shown in a table T360 of FIG. 3J, the leftmost column indicates the bits of the compressed weight 202 have been decoded and the rest of the columns indicate the data decoded from the compressed weight which reflects the original weight 201. Specifically, the first bit to the fifth bit (W[5:0]) have been decoded, and the sixth bit (W[0]) of the compressed weight 202 is decoded at the cycle 6 to obtain the data after the determined bit(s) of the decoded weight at the cycle 5 which reflects the data of the original weight 201. It is noted that, instead of being multiplied with the original weight 201, the input signal IN is multiplied with the determined data of the decoded weight which is decoded from the sixth bit (W[0]) of the compressed weight 202. Further, the determined data of the decoded weight is a multiplicand during the multiplication by the multiplier MP and the value of the multiplicand differs for different compressed weights 202.

In one embodiment, the value of W[5:0] of the compressed weight 202 is “000000”, “000010”, “100000”, “100010”. That is, at the cycle 6, the newly determined data reflects that the fourth bit (W[4]) of the original weight 201 is “0”. It is noted that, the newly determined “0” at the cycle 6 actually stands for “00000” in binary which means “0” in decimal. Therefore, the multiplicand used to be multiplied with the input signal IN is “0”.

In one embodiment, the value of W[5:0] of the compressed weight 202 is “000001”, “000011”, “100001”, “100011”. That is, at the cycle 6, the newly determined data reflects that the fourth bit (W[4]) of the original weight 201 is “1”. It is noted that, the newly determined “0” at the cycle 6 actually stands for “10000” in binary which means “16” in decimal. Therefore, the multiplicand used to be multiplied with the input signal IN is “16”.

In one embodiment, the value of W[5:0] of the compressed weight 202 is “000100”, “000110”, “100100”, “100110”. That is, at the cycle 6, the newly determined data reflects that the fifth bit (W[3]) of the original weight 201 is “0”. It is noted that, the newly determined “0” at the cycle 6 actually stands for “0000” in binary which means “0” in decimal. Therefore, the multiplicand used to be multiplied with the input signal IN is “0”.

In one embodiment, the value of W[5:0] of the compressed weight 202 is “000101”, “000111”, “100101”, “100111”. That is, at the cycle 6, the newly determined data reflects that the fifth bit (W[3]) of the original weight 201 is “1”. It is noted that, the newly determined “0” at the cycle 6 actually stands for “1000” in binary which means “8” in decimal. Therefore, the multiplicand used to be multiplied with the input signal IN is “8”.

In one embodiment, the value of W[5:0] of the compressed weight 202 is “001000”, “001010”, “101000”, “101010”. That is, at the cycle 6, the newly determined data reflects that the sixth bit (W[2]) of the original weight 201 is “0”. It is noted that, the newly determined “0” at the cycle 6 actually stands for “000” in binary which means “0” in decimal. Therefore, the multiplicand used to be multiplied with the input signal IN is “0”.

In one embodiment, the value of W[5:0] of the compressed weight 202 is “001001”, “001011”, “101001”, “101011”. That is, at the cycle 6, the newly determined data reflects that the sixth bit (W[2]) of the original weight 201 is “1”. It is noted that, the newly determined “1” at the cycle 6 actually stands for “100” in binary which means “4” in decimal. Therefore, the multiplicand used to be multiplied with the input signal IN is “4”.

In one embodiment, the value of W[5:0] of the compressed weight 202 is “001100”, “001110”, “101100”, “101110”. That is, at the cycle 6, the newly determined data reflects that the seventh bit (W[1]) of the original weight 201 is “0”. It is noted that, the newly determined “0” at the cycle 6 actually stands for “00” in binary which means “0” in decimal. Therefore, the multiplicand used to be multiplied with the input signal IN is “0”.

In one embodiment, the value of W[5:0] of the compressed weight 202 is “001101”, “001111”, “101101”, “101111”. That is, at the cycle 6, the newly determined data reflects that the seventh bit (W[1]) of the original weight 201 is “1”. It is noted that, the newly determined “0” at the cycle 6 actually stands for “10” in binary which means “2” in decimal. Therefore, the multiplicand used to be multiplied with the input signal IN is “2”.

In one embodiment, the value of W[5:0] of the compressed weight 202 is “010000”, “010010”, “110000”, “110010”. That is, at the cycle 6, the newly determined data reflects that the eighth bit (W[0]) of the original weight 201 is “0”. It is noted that, the newly determined “0” at the cycle 6 actually stands for “0” in binary which means “0” in decimal. Therefore, the multiplicand used to be multiplied with the input signal IN is “0”.

In one embodiment, the value of W[5:0] of the compressed weight 202 is “010001”, “010011”, “110001”, “110011”. That is, at the cycle 6, the newly determined data reflects that the eighth bit (W[0]) of the original weight 201 is “1”. It is noted that, the newly determined “1” at the cycle 6 actually stands for “1” in binary which means “1” in decimal. Therefore, the multiplicand used to be multiplied with the input signal IN is “1”.

In one embodiment, the value of W[5:0] of the compressed weight 202 is “010100”, “010101”, “010110”, “010111”, “011000”, “011001”, “011010”, “011011”, “011100”, “011101”, “011110”, “011111”, “110100”, “110101”, “110110”, “110111”, “111000”, “111001”, “111010”, “111011”, “111100”, “111101”, “111110”, or “111111”. It is noted that, since the eight bits (W[7] to W[0]) of the original weight 201 corresponding to these compressed weights 202 are all determined at the earlier clock cycle. Therefore, no newly determined data is obtained from theses weights 202 at the current clock cycle (cycle 6).

FIG. 3K is a schematic diagram of a multiplicand table of a decoder in accordance with some embodiments of the present disclosure. With reference to FIG. 1 to FIG. 3K, a multiplicand table T370 indicates the multiplicands being multiplied with the input signal IN during the multiplication by the multiplier MP for different compressed weights 202 at different clock cycles. For the convenience of explanation, compressed weights 202 that the corresponding multiplicands are “0” are not listed in the multiplicand table T370. Further, in the table T370, the valued bits (“1”) are highlighted and the unvalued bits (“0” and undetermined bits (X)) are not highlighted. The details of how the multiplicands are calculated may be refer to the description of FIG. 3A to FIG. 3J, while the details are not redundantly described seriatim herein.

It is noted that, the multiplicand table T370 may be configured to be stored in the weight decoder DE, so that the weight decoder DE may be configured to decode the compressed weight 202 based on the multiplicand table T370. That is, each bit of the compressed weight 202 may be directly decoded to obtain the decoded weight which reflects the data of the original weight 201. Therefore, the efficiency of the computation is improved and the energy consumption is reduced.

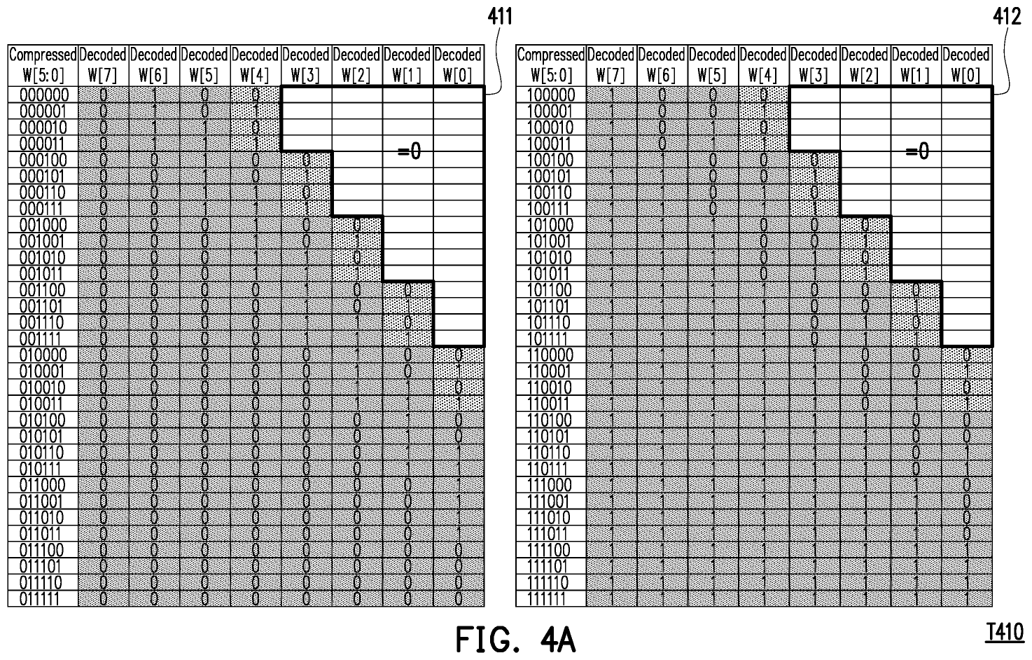

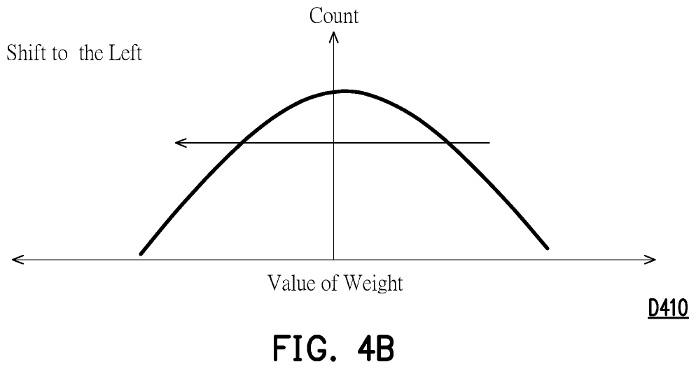

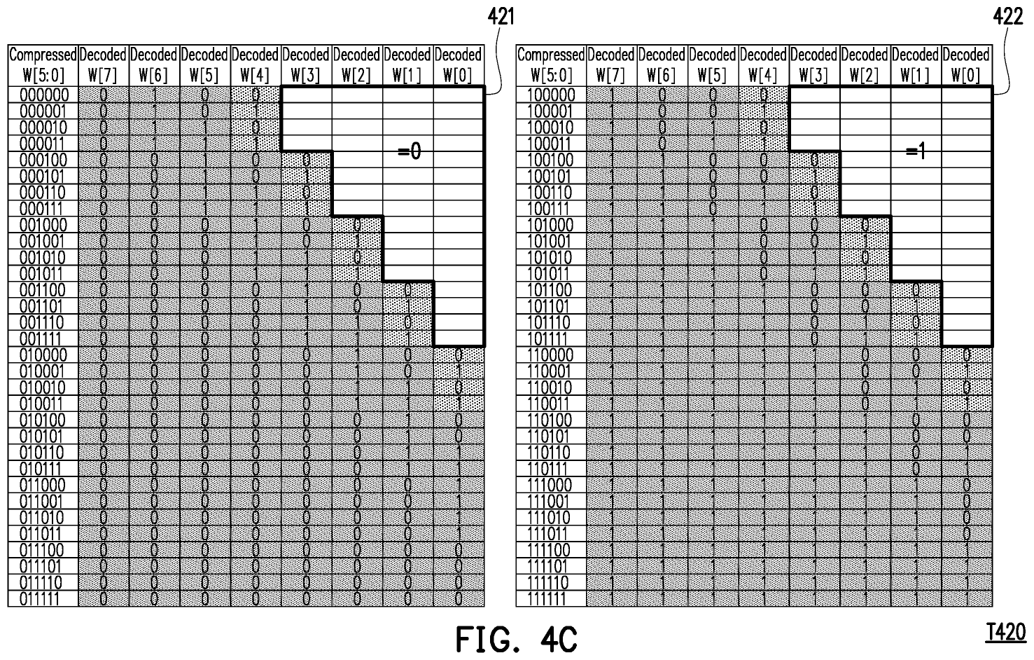

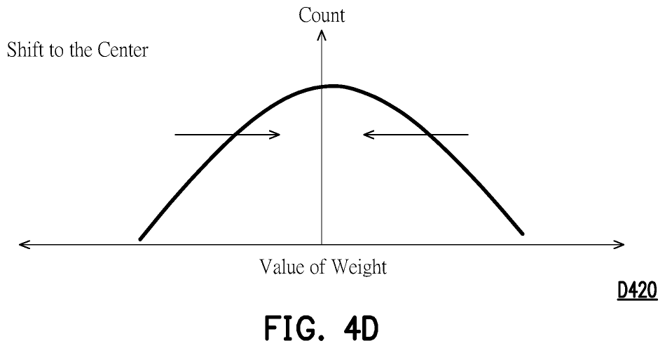

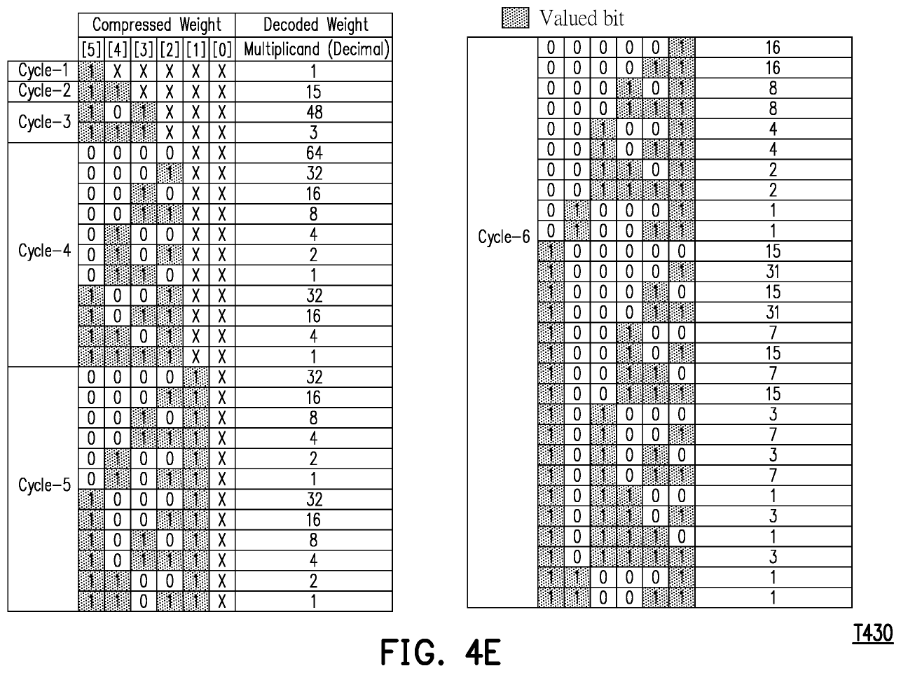

FIG. 4A is a schematic diagram of data obtained from a compressed weight in accordance with some embodiments of the present disclosure. With reference to FIG. 1 to FIG. 4A, a table T410 shows the decoded weights after fully decoding based on different compressed weights 202. It is noted that, for some decoded weights, all the bits are determined based on the corresponding compressed weights 202. That is, the decoded weights are exactly same as the original weights 201. For other decoded weights, as shown in a region 411 and a region 412, not all the bits are determined based on the corresponding compressed weights 202 and some of the bits of the decoded weights are still undetermined.

Comparing with the higher bits (determined bits) of the decoded weight, the amount of these undetermined bits is orders of magnitude smaller and may be negligible. In other words, these undetermined bits may be all determined as “0”. Therefore, even if some bits of the decoded weights are not determined based on the compressed weights 202, the decoded weights may still reflect the data of the original weights 201.

FIG. 4B is a schematic diagram of a distribution of the value of the weight in accordance with some embodiments of the present disclosure. With reference to FIG. 1 to FIG. 4B, a weight distribution D410 shows how a distribution of the values of the weights. The X-axis indicates the values of the weights and the Y-axis indicates a count (number) of the weights with a specific value.

It is noted that, as shown in the as shown in the region 411 and the region 412 of FIG. 4A, after the last clock cycle of the decoding, the undetermined bits of the decoded weights are determined as “0”. The undetermined bits of the decoded weights may correspond certain bits of the original weights 201. While the values of the certain bits of the original weights 201 are “0”, the values of the decoded weights are still same as the values of the original weights 201. While the values of the certain bits of the original weights 201 are not “0”, the values of the decoded weights would be smaller than the values of the original weights 201. That is, the weight distribution of the original weights 201 are shifted to the left to be the weight distribution of the decoded weights. In other words, the center of the weight distribution of the original weights 201 is left shifted and the center of the weight distribution of the decoded weights is no longer zero. However, the distance of the left-shifting may be small, and the difference would be negligible.

FIG. 4C is a schematic diagram of data obtained from a compressed weight in accordance with some embodiments of the present disclosure. With reference to FIG. 1 to FIG. 4C, a table T420 shows the decoded weights after fully decoding based on different compressed weights 202. It is noted that, for some decoded weights, all the bits are determined based on the corresponding compressed weights 202. That is, the decoded weights are exactly same as the original weights 201. For other decoded weights, as shown in the region 421 and the region 422, not all the bits are determined based on the corresponding compressed weights 202 and some of the bits of the decoded weights are still undetermined.

In this embodiment, the undetermined bits of the decoded weights may be determined based on the MSB (W[7]) of the decoded weight. Specifically, the values of the undetermined bits of decoded weight may be determined to have the value of the MSB (W[7]) of the decoded weight. As shown in a region 421, since the values of the MSB (W[7]) are “0”, the undetermined bits within the regions 421 are determined as “0”. As shown in a region 422, since the values of the MSB (W[7]) are “1”, the undetermined bits within the regions 422 are determined as “0”.

FIG. 4D is a schematic diagram of a distribution of the value of the weight in accordance with some embodiments of the present disclosure. With reference to FIG. 1 to FIG. 4B, a weight distribution D420 shows how a distribution of the values of the weights. The X-axis indicates the values of the weights and the Y-axis indicates a count (number) of the weights with a specific value.

It is noted that, as shown in the as shown in the region 421 and the region 422 of FIG. 4A, after the last clock cycle of the decoding, the undetermined bits of the decoded weights are determined as based on the value of the MSB (W[7]) of the decoded weights. The undetermined bits of the decoded weights may correspond certain bits of the original weights 201. While the values of the certain bits of the original weights 201 are “0”, the values of the decoded weights may be still same as the values of the original weights 201 or greater than the values of the original weights 201. While the values of the certain bits of the original weights 201 are not “0”, the values of the decoded weights may be same as the values of the original weights 201 or smaller than the values of the original weights 201. That is, the weight distribution of the original weights 201 are shifted to the center to be the weight distribution of the decoded weights. In other words, the center of the weight distribution of the original weights 201 is still zero and same as the center of the weight distribution of the original weights.

FIG. 4E is a schematic diagram of a multiplicand table of a decoder in accordance with some embodiments of the present disclosure. With reference to FIG. 1 to FIG. 4E, a multiplicand table T430 indicates the multiplicands being multiplied with the input signal IN during the multiplication by the multiplier MP for different compressed weights 202 at different clock cycles. Comparing with the multiplicand table 370 of FIG. 3K, the some of the multiplicand at the cycle 6 in the multiplicand table T430 of FIG. 4E are different. Specifically, at after the decoding of the cycle 6, the undetermined bits of the decoded weights are determined to follow the MSB (W[7]) of the decoded weight. For the decoded weights with the MSB (W[7]) being “0”, the corresponding multiplicands stay the same. For the decoded weights with the MSB (W[7]) being “1”, the corresponding multiplicands are different as described in the description of FIG. 4C and FIG. 4D. The details of how the multiplicands are calculated may be refer to the description of FIG. 3A to FIG. 3J, while the details are not redundantly described seriatim herein.

It is noted that, the multiplicand table T4300 may be configured to be stored in the weight decoder DE, so that the weight decoder DE may be configured to decode the compressed weight 202 based on the multiplicand table T4300. That is, each bit of the compressed weight 202 may be directly decoded to obtain the decoded weight which reflects the data of the original weight 201. Therefore, the efficiency of the computation is improved and the energy consumption is reduced.

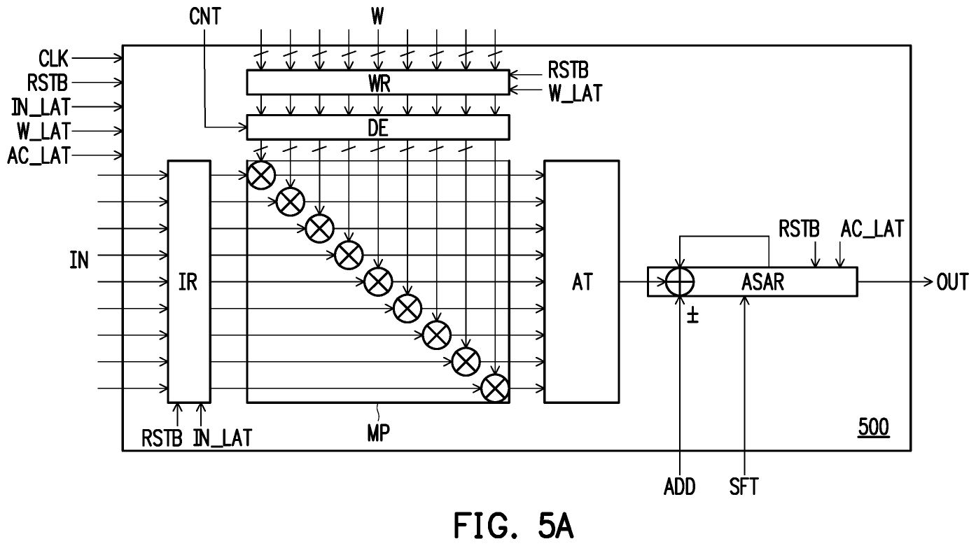

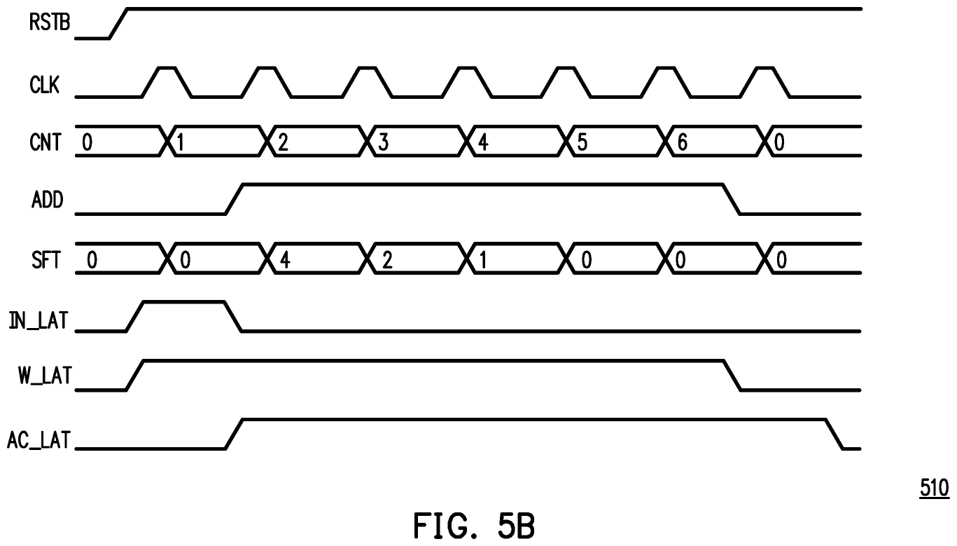

FIG. 5A is a schematic diagram illustrating a computing circuit in accordance with some embodiments of the present disclosure. With the reference to FIG. 1 to FIG. 5A, a computing circuit 500 of FIG. 5A is another embodiment different from the computing circuit 100 of FIG. 100. Comparing with the computing circuit 100, the computing circuit 500 further includes an input register IR and weight register WR. In addition, the accumulator of the computing circuit 100 is replaced with an accumulation shift and add register ASAR of the computing circuit 500.

In one embodiment, the computing circuit 500 is configured to receive a clock signal CLK, a reset bar signal RSTB, an input latch signal IN_LAT, a weight latch signal W_LAT, and an accumulation latch signal AC_LAT. The input register IR is coupled to the multiplier MP and is configured to receive the reset bar signal RSTB and the weight latch signal W_LAT. The input register IR is configured to latch the input signal IN in response to the input latch signal IN_LAT being enabled.

The weight register WR is coupled to the multiplier MP and is configured to receive the reset bar signal RSTB and the weight latch signal W_LAT. The reset bar signal RSTB is logically inverted to a rest signal (not shown). The weight register WR is configured to latch the compressed weight W in response to the weight latch signal W_LAT being enabled.

The accumulation shift and add register ASAR is configured to receive the reset bar signal RSTB, the accumulation latch signal AC_LAT, an add signal, and the shift signal SFT. The accumulation shift and add register ASAR is configured to latch the output of the adder tree AT in response to the accumulation latch signal AC_LAT being enabled and shift the accumulated sum leftward based on the shift signal SFT. Further, the accumulation shift and add register ASAR is configured to add the partial-sum from the adder tree AT with the accumulated sum in response to the add signal ADD being enabled and subtract the partial-sum from the accumulated sum in response to the add signal ADD being disabled.

Moreover, the input register IR, the weight register WR, and the accumulation shift and add register ASAR are configured to be enabled in response to the reset bar signal being enabled and to be reset in response to the reset bar signal being disabled. Besides, the weight decoder DE is configured to receive a count signal CNT to indicate a number of bits of the compressed weight W has been latched.

In this embodiment, the input signal IN includes nine input vectors and the compressed weight W includes nine compressed weight vectors. The nine input vectors are latched by the input register IR wordwise at one clock cycle and the nine compressed weight vectors are latched by the weight register WR bitwise at each clock cycle. The weight decoder DE is configured to generate nine decoded weights based on the nine compressed weight vectors. The multiplier MP is configured to multiply the nine input vectors with the nine decoded weight corresponding to one bit of the nine compressed weight vector, respectively, at each clock cycle. This disclosure does not limit the number of the input vectors and the number of the compressed weight vectors.

FIG. 5B is a timing chart of a high speed clock in accordance with some embodiments of the present disclosure. With reference to FIG. 1 to FIG. 5B, a timing chart 510 shows an embodiment of the waveforms of the signals of the computing circuit 500 of FIG. 5A.

In one embodiment, while a set of the input signal IN and the compressed weighted is ready for computation, the reset bar signal RSTB is switched from a logical low level (“0”) to a logical high level “1” to enable the input register IR, the weight register WR, and the accumulation shift and add register ASAR.

The clock signal CLK is switched from “0” to “1” (rising edge) and then switch from “1” to “0” (falling edge) to indicate a time length of each clock cycle. In this embodiment, since the compressed weight W includes 6 bits, the clock signal is configured to indicate 6 clock cycles for 6 decoding cycles and 1 cycle for 1 reset cycle.

The input latch signal IN_LAT is switched from “0” to “1” and the input register IR is configured to latch the input signal IN wordwise at a rising edge of a first clock cycle. After the latching of the input signal IN, the input latch signal IN_LAT is switched from “1” to “0”.

The weight latch signal W_LAT is switched from “0” to “1” and the weight register WR is configured to latch the compressed weight W bitwise at each clock cycle. After the latching of the compressed signal W, the weight latch signal W_LAT is switched from “1” to “0”. After one bit of the compressed weight W is latched, the data of the count signal CNT is increased by 1. In this embodiment, since the compressed weight W includes 6 bits, the data of the count signal CNT is increased from “0” to “6” from the first clock cycle to the sixth clock cycle and reset to “0” at the reset cycle.

The add signal ADD is “0” at the first clock cycle to indicate the MSB of the compressed weight is signed (negative) or unsigned (positive). The accumulation shift and add register ASAR is configured to give the accumulated sum a sign or not based on the add signal ADD. The add signal ADD is switched from “0” to “1” at the second clock cycle and is switched from “1” to “0” at the sixth clock cycle. The accumulation shift and add register ASAR is configured to add the partial-sum from the adder tree AT with the accumulated sum based on the add signal ADD.

The shift signal SFT is “0” at the first clock cycle, “4” at the second clock cycle, “2” at the third clock cycle, “1” at the fourth cycle, and “0” at the rest of the clock cycles. Since the first bit, the second bit, and the third bit of the run-length indicates the number of the following bits right after the MSB repeat the same value of the MSB, the accumulation shift and add register ASAR is configured to left-shifted the accumulated sum four bits, two bits, and one bit, from the second clock cycle to the fourth clock cycle, respectively, based on the shift signal SFT.

After the computation of the set of the input signal IN and the compressed weight W is done, the accumulation sum is output as the output signal OUT and the reset bar signal RSTB is switched from “1” to “0” to wait for the computation of a next set of the input signal IN and the compressed weight W.

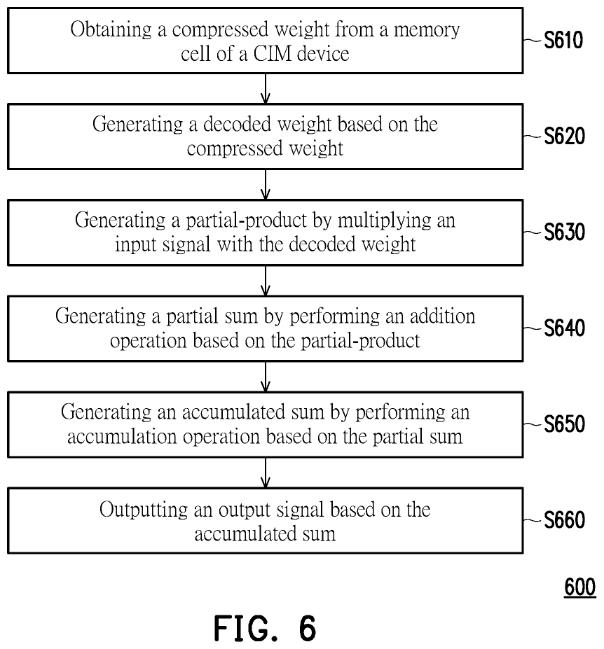

FIG. 6 is a schematic flowchart of a computing method of a memory cell in accordance with some embodiments of the present disclosure. With reference to FIG. 1 to FIG. 6, a computing method 600 is adapted to a CIM device and includes a step S610 to a step S660.

In the step S610, a compressed weight W is obtained from a memory cell of the CIM device by the weight decoder DE. In a step S620, a decoded weight is generated based on the compressed weight W by the weight decoder DE. In a step S630 a partial-product is generated by multiplying an input signal with the decoded weight by the multiplier MP. In a step S640, a partial-sum is generated by performing an addition operation based on the partial-product by the adder tree AT. In a step S650 an accumulated sum is generated by performing an accumulation operation based on the partial-sum by the accumulator ACC. In the step S660, an output signal is output based on the accumulated sum by the accumulator ACC. The accumulated sum is left shifted based on the shift signal SFT by the accumulator ACC. The details of the computing method 100 refer to the description of FIG. 1 to FIG. 5B, while the details are not redundantly described seriatim herein. In this manner, the efficiency of the computation is improved and the energy consumption is reduced.

Based on the above, by using a novel decoder to decode the compressed weights, the computation is directly performed on the compressed weights, and thereby reducing the amount of bits for computation and the area required for storing the compressed weights. Further, the compressed weights may have fixed data width, thus it is hardware friendly which is convenient to implement into a CIM device.

In one embodiment, a computing circuit is disposed in a memory device and electrically coupled to a memory cell of the memory device. The computing circuit includes:
a weight decoder, configured to obtain a compressed weight from the memory cell and generate a decoded weight based on the compressed weight; a multiplier, coupled to the weight decoder and configured to generate a partial-product by multiplying an input signal with the decoded weight; an adder tree, coupled to the multiplier and configured to generate a partial-sum by performing an addition operation based on the partial-product; and an accumulator, coupled to the adder tree and configured to generate an accumulated sum by performing an accumulation operation based on the partial-sum and output an output signal based on the accumulated sum. The accumulated sum is left shifted based on a shift signal.

In a related embodiment, the accumulator is configured to left shift the accumulated sum of a previous clock cycle based on the shift signal to generate a left-shifted accumulated sum of the previous clock cycle, and the accumulator is configured to accumulate the left-shifted accumulated sum of the previous clock cycle with the partial-sum of a current clock cycle to generate the accumulated sum of the current clock cycle.

In a related embodiment, the weight decoder is configured to decode the compressed weight during a plurality of clock cycles to generate the decoded weight, wherein a number of the plurality clock cycles is same as a number of bits of the compressed weight.

In a related embodiment, the weight decoder is configured to obtain the decoded weight bitwise from a most significant bit (MSB) of the compressed weight to a least significant bit (LSB) of the compressed weight, respectively, at each clock cycle of a plurality of clock cycles, and the weight decoder is configured to convert an undetermined bit of the decoded weight to a determined bit based on each bit of the compressed weight, respectively, at the each clock cycle of the plurality of clock cycles.

In a related embodiment, the weight decoder is configured to determine the undetermined bit of the decoded weight as zero after a last clock cycle of decoding.

In a related embodiment, the weight decoder is configured to determine the undetermined bit of the decoded weight to have a same value as the MSB after a last clock cycle of decoding.

In a related embodiment, the input signal is obtained wordwise at one clock cycle.

In a related embodiment, the compressed weight includes a prefix, a run-length, and a postfix, wherein the prefix indicates a MSB of an original weight, the run-length indicates a number of bits right after the MSB of the original weight having the same value as the MSB, and the postfix indicates the data of the original weight that is not represented by the prefix and the run-length.

In a related embodiment, the weight decoder is configured to store a multiplicand table, wherein the multiplicand table includes a plurality of multiplicands corresponding to the prefix, the run-length, and the postfix of the compressed weight.

In a related embodiment, the weight decoder is configured to output a decoded multiplicand as the decoded weight corresponding to on the compressed weight based on multiplicand table.

In another embodiment, a computing method is adapted to a compute-in-memory (CIM) device. The computing method includes: obtaining a compressed weight from a memory cell of the CIM device; generating a decoded weight based on the compressed weight; generating a partial-product by multiplying an input signal with the decoded weight; generating a partial-sum by performing an addition operation based on the partial-product; generating an accumulated sum by performing an accumulation operation based on the partial-sum; and outputting an output signal based on the accumulated sum. The accumulated sum is left shifted based on a shift signal.

In a related embodiment, the computing method further includes: left-shifting the accumulated sum of a previous clock cycle based on the shift signal to generate a left-shifted accumulated sum of the previous clock cycle; and accumulating the left-shifted accumulated sum of the previous clock cycle with the partial-sum of a current clock cycle to generate the accumulated sum of the current clock cycle.

In a related embodiment, the computing method further includes: decoding the compressed weight during a plurality of clock cycles to generate the decoded weight, wherein a number of the plurality clock cycles is same as a number of bits of the compressed weight.

In a related embodiment, the computing method further includes: obtaining the decoded weight bitwise from a most significant bit (MSB) of the compressed weight to a least significant bit (LSB) of the compressed weight, respectively, at each clock cycle of a plurality of clock cycles; and converting an undetermined bit of the decoded weight to a determined bit based on each bit of the compressed weight, respectively, at the each clock cycle of the plurality of clock cycles.

In a related embodiment, the computing method further includes: determining the undetermined bit of the decoded weight as zero after a last clock cycle of decoding.

In a related embodiment, the computing method further includes: determining the undetermined bit of the decoded weight to have a same value as the MSB after a last clock cycle of decoding.

In a related embodiment, the compressed weight includes a prefix, a run-length, and a postfix, wherein the prefix indicates a MSB of an original weight, the run-length indicates a number of bits right after the MSB of the original weight having the same value as the MSB, and the postfix indicates the data of the original weight that is not represented by the prefix and the run-length.

In yet another embodiment, a decoder for a compute-in-memory (CIM) device is configured to: decode a compressed weight, wherein the compressed weight includes a prefix, a run-length, and a postfix, the prefix indicates a MSB of an original weight, the run-length indicates a number of bits right after the MSB of the original weight having the same value as the MSB, and the postfix indicates the data of the original weight that is not represented by the prefix and the run-length; and generate a decoded weight based on the compress weight.

In a related embodiment, the decoder is further configured to store a multiplicand table, wherein the multiplicand table includes a plurality of multiplicands corresponding to the prefix, the run-length, and the postfix of the compressed weight.

In a related embodiment, the decoder is further configured to output a decoded multiplicand as the decoded weight corresponding to on the compressed weight based on multiplicand table.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computing circuit, disposed in a memory device and electrically coupled to a memory cell of the memory device, wherein the computing circuit comprises:
a weight decoder, configured to obtain a compressed weight from the memory cell and generate a decoded weight based on the compressed weight;
a multiplier, coupled to the weight decoder and configured to generate a partial-product by multiplying an input signal with the decoded weight;
an adder tree, coupled to the multiplier and configured to generate a partial-sum by performing an addition operation based on the partial-product; and
an accumulator, coupled to the adder tree and configured to generate an accumulated sum by performing an accumulation operation based on the partial-sum and output an output signal based on the accumulated sum,
wherein the accumulated sum is left shifted based on a shift signal.

2. The memory test circuit according to claim 1, wherein
the accumulator is configured to left shift the accumulated sum of a previous clock cycle based on the shift signal to generate a left-shifted accumulated sum of the previous clock cycle, and
the accumulator is configured to accumulate the left-shifted accumulated sum of the previous clock cycle with the partial-sum of a current clock cycle to generate the accumulated sum of the current clock cycle.

3. The memory test circuit according to claim 1, wherein
the weight decoder is configured to decode the compressed weight during a plurality of clock cycles to generate the decoded weight, wherein a number of the plurality clock cycles is same as a number of bits of the compressed weight.

4. The memory test circuit according to claim 1, wherein
the weight decoder is configured to obtain the decoded weight bitwise from a most significant bit (MSB) of the compressed weight to a least significant bit (LSB) of the compressed weight, respectively, at each clock cycle of a plurality of clock cycles, and
the weight decoder is configured to convert an undetermined bit of the decoded weight to a determined bit based on each bit of the compressed weight, respectively, at the each clock cycle of the plurality of clock cycles.

5. The memory test circuit according to claim 4, wherein
the weight decoder is configured to determine the undetermined bit of the decoded weight as zero after a last clock cycle of decoding.

6. The memory test circuit according to claim 4, wherein
the weight decoder is configured to determine the undetermined bit of the decoded weight to have a same value as the MSB after a last clock cycle of decoding.

7. The memory test circuit according to claim 1, wherein
the input signal is obtained wordwise at one clock cycle.

8. The memory test circuit according to claim 1, wherein
the compressed weight comprises a prefix, a run-length, and a postfix,
wherein the prefix indicates a MSB of an original weight, the run-length indicates a number of bits right after the MSB of the original weight having the same value as the MSB, and the postfix indicates the data of the original weight that is not represented by the prefix and the run-length.

9. The memory test circuit according to claim 8, wherein
the weight decoder is configured to store a multiplicand table, wherein the multiplicand table comprises a plurality of multiplicands corresponding to the prefix, the run-length, and the postfix of the compressed weight.

10. The memory test circuit according to claim 9, wherein
the weight decoder is configured to output a decoded multiplicand as the decoded weight corresponding to on the compressed weight based on multiplicand table.

11. A computing method, adapted to a compute-in-memory (CIM) device, wherein the computing method comprises:
obtaining a compressed weight from a memory cell of the CIM device;
generating a decoded weight based on the compressed weight;
generating a partial-product by multiplying an input signal with the decoded weight;
generating a partial-sum by performing an addition operation based on the partial-product;
generating an accumulated sum by performing an accumulation operation based on the partial-sum; and
outputting an output signal based on the accumulated sum,
wherein the accumulated sum is left shifted based on a shift signal.

12. The computing method according to claim 11, further comprising:
left-shifting the accumulated sum of a previous clock cycle based on the shift signal to generate a left-shifted accumulated sum of the previous clock cycle; and
accumulating the left-shifted accumulated sum of the previous clock cycle with the partial-sum of a current clock cycle to generate the accumulated sum of the current clock cycle.

13. The computing method according to claim 11, further comprising:
decoding the compressed weight during a plurality of clock cycles to generate the decoded weight, wherein a number of the plurality clock cycles is same as a number of bits of the compressed weight.

14. The computing method according to claim 11, further comprising:
obtaining the decoded weight bitwise from a most significant bit (MSB) of the compressed weight to a least significant bit (LSB) of the compressed weight, respectively, at each clock cycle of a plurality of clock cycles; and
converting an undetermined bit of the decoded weight to a determined bit based on each bit of the compressed weight, respectively, at the each clock cycle of the plurality of clock cycles.

15. The computing method according to claim 14, further comprising:
determining the undetermined bit of the decoded weight as zero after a last clock cycle of decoding.

16. The computing method according to claim 14, further comprising:
determining the undetermined bit of the decoded weight to have a same value as the MSB after a last clock cycle of decoding.

17. The computing method according to claim 11, wherein
the compressed weight comprises a prefix, a run-length, and a postfix,
wherein the prefix indicates a MSB of an original weight, the run-length indicates a number of bits right after the MSB of the original weight having the same value as the MSB, and the postfix indicates the data of the original weight that is not represented by the prefix and the run-length.

18. A decoder for a compute-in-memory (CIM) device, wherein the decoder is configured to:
decode a compressed weight, wherein the compressed weight comprises a prefix, a run-length, and a postfix, the prefix indicates a MSB of an original weight, the run-length indicates a number of bits right after the MSB of the original weight having the same value as the MSB, and the postfix indicates the data of the original weight that is not represented by the prefix and the run-length; and
generate a decoded weight based on the compress weight.

19. The decoder according to claim 18, wherein the decoder is further configured to:
store a multiplicand table, wherein the multiplicand table comprises a plurality of multiplicands corresponding to the prefix, the run-length, and the postfix of the compressed weight.

20. The decoder according to claim 19, wherein the decoder is configured to:
output a decoded multiplicand as the decoded weight corresponding to on the compressed weight based on multiplicand table.
